(19) United States
(12) Patent Application Publication
(10) Pub. No.: US 2022/0073350 A1
(43) Pub. Date: Mar. 10, 2022

(54) TWO-DIMENSIONAL ARRAYS OF TRANSITION METAL NITRIDE NANOCRYSTALS

(71) Applicant: Drexel University, Philadelphia, PA (US)

(72) Inventors: Yury GOGOTSI, Warminster, PA (US); Xu XIAO, Philadelphia, PA (US); Hao WANG, Philadelphia, PA (US); Patrick URBANKOWSKI, Philadelphia, PA (US)

(21) Appl. No.: 17/419,803

(22) PCT Filed: Dec. 19, 2019
(86) PCT No.: PCT/US2019/067429

§ 371 Date: Jun. 30, 2021

Related U.S. Application Data
(60) Provisional application No. 62/787,501, filed on Jan. 2, 2019.

(51) Int. Cl. C01B 21/06; C01B 21/076; H01M 4/58

(52) U.S. Cl. CPC C01B 21/0617; C01B 21/062; B82Y 30/00; H01M 4/58; C01B 21/076

(57) ABSTRACT

The present disclosure relates to the methods of preparing two-dimensional arrays of nanocrystalline metal carbide and metal nitride compositions and the compositions and devices derived from these methods and compositions.

### CROSS REFERENCE TO RELATED APPLICATIONS

The present application claims priority to and the benefit of U.S. patent application No. 62/787,501, “Two-Dimensional Arrays of Transition Metal Nitride Nanocrystals” (filed Jan. 2, 2019), the entirety of which application is incorporated herein by reference for any and all purposes.

### GOVERNMENT RIGHTS

This invention was made with government support under Contract No. DE-SC0018618 awarded by the Department of Energy. The government has certain rights in the invention.

### TECHNICAL FIELD

The present disclosure relates to methods of preparing of two-dimensional metal nitride nanocrystals and the compositions and devices derived from these methods.

### BACKGROUND

Two-dimensional (“2D”) transition metal nitride (“TMN”) nanomaterials have recently entered the research arena, but already offer a potential for high-rate energy storage. Such storage is needed for portable/wearable electronics and many other applications. However, the availability of available synthesis methods for 2D metal nitrides is limited. Accordingly, there is a long felt need for such materials and related methods of producing them.

### SUMMARY

Due to the recent demonstration of promising properties of transition metal nitride (TMN) nanomaterials in fields ranging from plasmonics to energy harvesting, conversion and storage, the research of TMN nanomaterials especially the development of new synthesis techniques and material applications, has attracted great attention. In particular, there are two major challenges remaining in the cathodes of lithium-sulfur (Li—S) batteries—full utilization of sulfur and strong affinity between host materials and sulfur species. Interestingly, TMNs have been validated to have a strong interaction with sulfur species, in contrast to widely studied carbon materials. Combined with high electrical conductivity, TMN nanomaterials can help alleviate challenges. However, it should be noted that the promising performance was mainly achieved on low areal sulfur loading (below 3 mg cm⁻²) previously, while reaching the high and stable capacity during long-term cycling (>500 cycles) are still challenging but highly demanded for high areal sulfur loading cathode. This is due to the fact that the structure and conductivity cannot be optimized simultaneously in conventional synthesis methods, which is also a common issue in many research fields.

In general, zero-dimensional (0D) nanoparticles with very high surface area can provide highly exposed active sites. However, electron transport severely decreases if there are only physical contacts between self-assembled nanocrystals. On the other hand, two-dimensional (2D) metallically conducting flakes can conduct electrons to the less conducting material at their surface. For instance, a restacked MXene film shows an excellent conductivity, up to 8000 S cm⁻¹. Nevertheless, such a dense film (3-4 g cm⁻³) is not favorable for ultrahigh rate ion transport Designing a nanostructure that takes advantages of both 0D and 2D morphologies may enable conductivity and accessibility simultaneously.

However, TMN nanostructures synthesized with current strategies do not allow reaching the maximum conductivity and accessibility of active sites simultaneously, which are crucial factors for many important applications in plasmonics, energy storage, catalysis, sensing, etc. Given the importance of these nitride materials, it is at least highly desirable to develop additional efficient and scalable synthetic processes for 2D transition metal carbides and nitride nanocrystals, which can be used for energy storage, electrocatalysis, electromagnetic interference shielding and other applications that require high electronic conductivity.

Herein are disclosed unique interconnected 2D arrays of few-nanometer TMN nanocrystals that are obtained through a topochemical synthesis on the surface of a salt template. As a simple demonstration of their application in a lithium-sulfur battery, it is shown that such a unique nanostructure can produce a highly stable and reversible capacity for 1000 cycles under a high areal sulfur loading (>5 mg cm²), which is attributed to both the strong interaction with sulfur species and the fast electron/ion transport in these nanostructures. This synthesis procedure paves a general approach to realizing novel nanostructures and may be expanded to other material systems.

In one aspect, the present disclosure provides methods of preparing a crystalline two-dimensional transition metal composition, comprising: reacting a transition metal precursor, dispersed within a crystalline salt matrix, with an amine, in an otherwise non-oxidative or inert environment, for a time and under conditions sufficient so as to form the corresponding two-dimensional transition metal nitride, admixed in the crystalline salt matrix, wherein the transition metal precursor optionally comprises at least one transition metal of Group 4 to 6 of the Periodic Table.

In another aspect, the present disclosure provides a method of preparing a crystalline two-dimensional transition metal composition, comprising: reacting a transition metal precursor, dispersed within a crystalline salt matrix, with a carbonaceous material, in an otherwise non-oxidative or inert environment, for a time and under conditions sufficient so as to form the corresponding two-dimensional transition metal carbide, admixed in the crystalline salt matrix, wherein the transition metal precursor optionally comprises at least one transition metal of Group 4 to 6 of the Periodic Table.

Also provided are compositions comprising a layered array of crystalline two-dimensional metal nitride, present as flakes, said flakes prepared by or preparable by the methods disclosed herein.

Additionally disclosed are compositions comprising a layered array of crystalline two-dimensional metal carbide, present as flakes, said flakes prepared by or preparable by the disclosed methods.

Further provided are electronic devices comprising a composition according to the present disclosure, wherein the electronic device is preferably an energy storage device, more preferably a battery, or a device useful for electrocatalysis, electromagnetic interference shielding or other applications that require high electronic conductivity

Also disclosed are compositions or electronic devices according to the present disclosure, characterized in a manner as described herein.

Further provided are compositions, comprising: a layered array of crystalline two-dimensional transition metal nitride or a layered array of crystalline two-dimensional transition metal carbide, optionally present as flakes.

Additionally disclosed are compositions, comprising: a layered array of crystalline two-dimensional transition metal nitride or a layered array of crystalline two-dimensional transition metal carbide, optionally present as flakes.

Also disclosed are electrical cells, comprising a cathode comprising the composition as described herein and further comprising an electrode that comprises lithium.

Additionally provided are batteries, comprising: a cathode, the cathode comprising an amount of two-dimensional transition metal carbide and/or transition metal nitride, and an amount of sulfide or sulfur, the cathode further optionally comprising an amount of a MXene material; an anode, the anode comprising an amount of two-dimensional transition metal carbide and/or transition metal nitride, and an amount of lithium, the anode further optionally comprising an amount of a MXene material.

### BRIEF DESCRIPTION OF THE DRAWINGS

The present application is further understood when read in conjunction with the incorporated drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. The drawings are as described herein.

FIG. 1 provides illustrative synthesis and characterization of 2D arrays of TMN nanocrystals. (a) Schematic of synthesis. The precursor solution in ethanol was poured into a large amount of a salt template. After stirring and drying in an oven, a thin layer of precursor was formed on the surface of salts (labeled and referred to as precursor@salt). Then the precursor@salt powder was treated in a furnace at high temperature under a constant flow of ammonia. Finally, after dissolving the salt-template (which can be collected and recycled), 2D arrays of TMN nanocrystals were obtained. (b) Optical images of colloidal solutions of TMN nanocrystals dispersed in deionized water. (c-e) TEM images of the 2D arrays of TMN nanocrystals. Scale bars are 200 nm for (c) and (e), 500 nm for (d). The insets show that 2D flakes are made of interconnected TMN nanocrystals. Scale bars are 10 nm. (f˜h) HRTEM images of TMN nanocrystals shown in (c-e). Scale bars are 5 Å. (i) XRD patterns of 2D arrays of TMN nanocrystals. (j) N is XPS spectra of 2D arrays of TMN nanocrystals.

FIG. 2 provides exemplary X-ray PDF analysis of 2D arrays of TMN nanocrystals. The black line is the experimentally determined PDF, the red line is the PDF of the best-fit model obtained from the proposed crystal structure. The navy line showing offset below the data is the difference between fitting results and experimental data.

FIG. 3 provides an exemplary growth mechanism of 2D arrays of TMN nanocrystals. (a-d) TEM images show the morphology change during treatment. Samples were ammoniated at different temperatures, but same dwell time, followed by dissolution of the salt-templates. Scale bar 200 nm. (e) Schematic of the changes of morphology at different temperatures. (f) and (g) XRD and XPS analyses of the samples treated at different temperatures.

FIG. 4 provides exemplary Li—S battery performance of 2D arrays of TMN nanocrystals/sulfur composites. (a) Ultraviolet/visible absorption spectra of a Li₂S₆ solution before and after the addition of 2D arrays of NbN nanocrystal powder for 5 and 10 minutes. It should be noted that the absorption background deviation is due to the particle scattering. The insets show optical images of Li₂S₆ solution before and 5 minutes after the addition of NbN nanocrystal powder. (b) Cyclic voltammetry curves of a Li—S cell with a NbN/S cathode at a scan rate of 0.1 mV s⁻¹. (c) Cycling performance of Li—S cells with CrN/S, TiN/S and NbN/S cathodes at 0.2 C for 100 cycles (1 C=1673 mA g⁻¹). (d) Charge/discharge profiles of a NbN/S cathode with 5.1 mg cm⁻² sulfur loading at rates from 0.2 C to 5 C. (e) Rate capability of NbN/S-2.0 and NbN/S-5.1 cathodes at rates from 0.2 C to 5 C. (e) Rate capability of NbN/S-2.0 and NbN/S-5.1 cathodes at rates from 0.2 C to 5 C. (f) Cycling performance of NbN/S-5.1 cathode at 1 C for 1000 cycles.

FIG. 5 provides example thicknesses of 2D arrays of TMN nanocrystals performed by atomic force microscopy (AFM). (a) CrN, (b) TiN, and (c) NbN. Scale bar, 50 nm. The red line shows where the profile curves were measured.

FIG. 6 provides exemplary domain size of 2D arrays of TMN nanocrystals determined by measuring the size of nanocrystals in TEM images. (a) CrN, (b) TiN, and (c) NbN.

FIG. 7 provides nitrogen adsorption/desorption isotherms used to calculate the specific surface area of 2D arrays of TMN nanocrystals. (a) CrN, 153 m² g⁻¹ (b) TiN, 57 m² g⁻¹ and (c) NbN, 88 m² g⁻¹.

FIG. 8 provides example HRTEM images of TMN nanocrystals. Scale bar, 0.5 nm. Besides square symmetry shown in FIGS. 1(F-H), hexagonal symmetry was also observed for some nanocrystals, which presents the d-spacing values of (200) and (111) lattice planes with an angle of about 55°, on the [01̅0] zone axis.

FIG. 9 provides example XPS spectra showing the chemical composition of 2D arrays of TMN nanocrystals. (a) Cr 2p region of CrN, (b) Ti 2p region of TiN, and (c) Nb 3d region of NbN.

FIG. 10 provides example XPS spectra showing the chemical composition of 2D arrays of CrN nanocrystals obtained at different temperatures. (a) 400° C., (b) 500° C., and (c) 600° C.

FIG. 11 provides example morphologies of samples synthesized in air and Ar. TEM images of Cr-precursor treated in air (a) and Ar (b). Scale bar, 100 nm.

FIG. 12 provides example digital images of Li₂S₆ (5 mM solution in a mixture of 1, 3-dioxolane and 1, 2-dimethoxyethane solvents) adsorptivity of TMN nanocrystals powder. 20 mg of TMN nanocrystals powder was soaked in 10 mL of 5 mM Li₂S₆ solution at 25° C.

FIG. 13 provides example thermogravimetric curves of TMN/S composites obtained in He atmosphere at 10° C./min. (a) CrN/S, (b) TiN/S, and (c) NbN/S.

FIG. 14 provides example XRD patterns of TMN/S composites, indicating the presence of S in the samples.

FIG. 15 provides example TEM image and EDS maps of NbN/S composite.

FIG. 16 provides example XPS spectra showing the chemical composition of NbN/S composite before and after cycling. Before cycling, there are only two sets of peaks, which are assigned to S—Nb bonds and S₈, respectively. After cycling, another set of peak appears which belongs to Li₂S.

FIG. 17 provides example cyclic voltamograms of TMN/S composites. (a) CrN/S, and (b) TiN/S. The scan rate was 0.1 mV/s.

FIG. 18 provides illustrative cycling stability of TMN/S electrodes with areal sulfur loading of 2.0 mg cm⁻² (labeled as TMN/S-2.0) at 0.5 C (875 mA g⁻¹).

FIG. 19 provides example charge/discharge profiles of NbN/S composite with areal sulfur loading of 2.0 mg cm⁻² (labeled as NbN/S-2.0). (a) The first, 150th and 300th charge/discharge profiles, (b) charge/discharge profiles at different rates.

FIG. 20 provides example cycling stability of NbN/S composite. Given the high conductivity of 2D arrays of TMN nanocrystals, we fabricated an electrode without carbon black additive. The long-term stability of this electrode is very similar to the conventional electrode.

FIG. 21 provides an exemplary cross-sectional scanning electron microscopy (SEM) image of a film comprising MXene was dropped into the solution of 2D arrays of transition metal nitrides and carbides nanocrystals.

FIG. 22 provides example cycling performance for NbN/Ti₃C₂ freestanding films with different ratios (NbN-number means the weight percentage of NbN in film).

### DETAILED DESCRIPTION OF ILLUSTRATIVE EMBODIMENTS

The present invention may be understood more readily by reference to the following description taken in connection with the accompanying Figures and Examples, all of which form a part of this disclosure. It is to be understood that this invention is not limited to the specific products, methods, conditions or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using). Again, embodiments directed to methods of making a composition also provide embodiments for the compositions themselves.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others. For example, in the present disclosure, the formation of the nitrides is described in the Examples as comprising three optional steps: (1) forming a salt matrix comprising a transition metal precursor crystalline salt to form a reaction precursor; (2) reacting this reaction precursor under otherwise inert (non-oxidative) environment, but comprising a hydrocarbon or an amine to form a product matrix comprising a transition metal nitride and the crystalline salt; and (3) dissolving the salt to provide the product two-dimensional nitride or carbide nanocrystals. In this case, steps (1), (2), and (3) each individually represent independent embodiments, as do steps (1) and (2), (2) and (3), and the combination of steps (1), (2), and (3). In the cases of multiple steps, each step may be conducted sequentially or at the same time.

The transitional terms “comprising,” “consisting essentially of” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially of” For those embodiments provided in terms of “consisting essentially of,” the basic and novel characteristic(s) is the facile operability of the methods (or the systems used in such methods or the compositions derived therefrom) to provide 2D (transition) transition metal carbides or nitrides.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.” Similarly, a designation such as C₁₋₃ includes C₁, C₂, C₃, C₁₋₂, C₂₋₃, C_{1,3}, as separate embodiments, as well as C₁₋₃.

Throughout this specification, words are to be afforded their normal meaning, as would be understood by those skilled in the relevant art. However, so as to avoid misunderstanding, the meanings of certain terms will be specifically defined or clarified.

The terms “2D (transition) metal carbide” or “2D (transition) metal nitride” refers to a crystalline metal carbide or nitride composition (including those comprising transition metal carbides or nitrides) having lattices which extend in two-dimensions (e.g., the x-y plane), such as associated sheets of (transition) metal atoms and carbon/nitrogen atoms, with nanometer(s) thickness or little or no extended crystalline structure (i.e., single or few unit cells directed) in the third dimension (e.g., the z-direction). While the methods may provide transition metal carbide or nitride compositions in powder form (which may be amorphous, semicrystalline, but generally crystalline morphology, or the crystallite size may be so small as to exhibit poor XRD definition or patterns), a feature of these 2D structures is their proclivity to form macroscopic flake structures, and in other embodiments, the 2D (transition) metal carbides or nitrides may be described in terms of having a (graphite-like) flake morphology. In some embodiments, and as shown herein, the sheets of (transition) metal atoms contain coatings of oxygenated or other heteroatom moieties. While these sheets may stack upon one another to form stacked assemblies, the bonding between adjacent sheets may be non-covalent. This contrasts the formation of macrostructured, crystalline materials. Transmission electron microscopy is useful in distinguishing such structures and for characterizing the 2D products as such.

“Optional” or “optionally” means that the subsequently described circumstance may or may not occur, so that the description includes instances where the circumstance occurs and instances where it does not.

Herein is reported unique interconnected 2D arrays of few-nanometer TMN nanocrystals which are obtained through a topochemical synthesis on the surface of a salt template. As a simple demonstration of their application in a lithium-sulfur battery, it is shown that such a unique nanostructure can produce and has produced a highly stable and reversible capacity for 1000 cycles under a high areal sulfur loading (>5 mg cm⁻²), which is attributed to both the strong interaction with sulfur species and the fast electron/ion transport in these nanostructures.

The present invention is directed to two-dimensional transition metal carbides and nitrides, and compositions further comprising lithium sulfides, and methods of making the same. In certain of the embodiments, the methods comprise reacting a transition metal precursor salt (i.e., not a metal oxide), dispersed within a salt matrix, with a hydrocarbon or an amine in a non-oxidative or inert environment, for a time and under conditions sufficient so as to form the corresponding two-dimensional transition metal carbide or nitride, wherein the transition metal precursor comprises a metal of Group 3 to 14 of the Periodic Table, preferably a metal of Group 3 to 12 or Group 3 to 6.

Again, as described elsewhere herein, the present invention is directed to methods for preparing two-dimensional transition metal carbide or metal nitride compositions. In certain embodiments, the methods comprise reacting a transition metal precursor, dispersed within a salt matrix (e.g.), the transition metal precursor coating the salt crystals, with a hydrocarbon or amine, respectively, in a non-oxidative or inert environment, for a time and under conditions sufficient so as to form the corresponding two-dimensional metal carbide or metal nitride composition, wherein the metal precursor optionally is and comprises a metal of Group 3 to 14 of the Periodic Table. In further embodiments, the metal precursor comprises at least transition metal of any one of Groups 3 to 6 of the Periodic Table. In still other embodiments, the metal precursor comprises Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, or a combination thereof, preferably Ti, Zr, Hf, V, Nb, Ta, Cr, Mo, W, Mn, Re, Fe, Ru, Os, Co, Rh, Ir, Ni, Cu, Zn, or a combination thereof, more preferably Zr, Hf, V, Nb, Ta, Mo, W, Mn, or a combination thereof, still more preferably Ti, V, Nb, Ta, Mo, W, or a combination thereof, and most preferably Cr, Ti, Nb, or a combination thereof. In some embodiments, the metal (M′) nitrides are of the formula M′N, M′₂N, or M′₃N₂. It is to be appreciated that each individual metal precursor, or combination of any two or more precursors represents an independent embodiment.

In some embodiments, the metal precursor is loaded onto the salt matrix and dried to remove the solution solvent and the dried precursor coated salt is heat treated under inert atmosphere but in the presence of a hydrocarbon or an amine source. Exemplary temperatures for this treatment include heating at temperatures in a range of from about 400° C. to about 450° C., from about 450° C. to about 500° C., from about 500° C. to about 550° C., from about 550° C. to about 600° C., or a combination of two or more of these ranges.

As specified elsewhere herein, the transition metal precursors are non-crystalline, and may be salts or organometallic compounds. In some embodiments, the transition metal precursor is a halide (e.g., chloride, bromide, or iodide), a nitrate, or sulfate, or a C₁₋₆ alkoxide or aryloxide, e.g., methoxide, ethoxide, propoxide, butoxide, or pentoxide, or phenoxide.

In some embodiments, the crystalline two-dimensional metal carbides are formed by reacting the transition metal precursor/salt matrix with a hydrocarbon under otherwise reducing, non-oxidative, or inert conditions. Exemplary hydrocarbons include alkanes, for example methane, ethane, ethylene, propane, propylene, or a combination thereof, more preferably methane.

In some embodiments, the two-dimensional metal nitride compositions are formed by reacting the transition metal precursor/salt matrix with an amine under the non-oxidative, inert, or reducing conditions. Exemplary amines include ammonia, methyl amine, ethyl amine, propyl amine, cyanoamine, cyanamide, cyanourea, melamine, or a combination thereof. Ammonia is preferred for this purpose. As exemplified herein, the crystalline two-dimensional metal nitride composition comprises a nitride of Ti, Cr, Nb, Ta, Mo, W, or a combination thereof are particularly attractive, especially a nitride of Ti, Cr, and Nb.

The methods are thus far described in term of a non-oxidative, inert, or reducing environment. As described herein, the terms “inert environment” is substantially free of oxidizable species, such as air or oxygen, where substantially free refers to the absence of oxidizable species sufficient to compromise the desired reaction or the integrity of the corresponding crystalline two-dimensional transition metal carbide or metal nitride composition. While not necessary for the present methods, “reducing conditions” may include the additional presence of hydrogen in these reactions. However, more typically, the otherwise inert environment comprises the use of nitrogen, argon, or other gas inert to (non-reactive under) the reaction conditions.

In some aspects, the salt appears to provide a templating effect, to maintain the correct morphology during the reaction of the templated transition metal precursor with the amine or hydrocarbons. These salts, therefor are preferably inert to both oxidizing and reducing conditions. In preferred embodiments, the salts are preferably water-soluble alkali metal halides or sulfates or alkaline earth metal halides of sulfates, for example, MgCl₂, CaCl₂, SrCl₂, BaCl₂, NaCl, NaBr, NaI, KCl, KBr, KI, RbCl, RbBr, RbI, CsCl, CsBr, CsI, MgSO₄, CaSO₄, SrSO₄, BaSO₄, Na₂(SO₄), K₂(SO₄), Rb₂(SO₄), Cs₂(SO₄), or a combination thereof. In more preferred embodiments, the salts comprise NaCl, KCl, CsCl₂, Na₂SO₄, K₂SO₄, MgSO₄, or a combination thereof.

In certain embodiments, the weight ratio of the transition metal precursor to the crystalline salt is in a range of from about 1:1 to about 1:10, from about 1:10 to about 1:100, from about 1:100 to about 1:500, from about 1:500 to about 1:1000, from about 1:1000 to about 1:2500, from about 1:2500 to about 1:5000, or a combination of two or more of these ranges. As described in the Examples, compositions in which the weight ratio of the metal precursor to the salt in a range of from about 1:750 to about 1:1250, or about 1:1000 appears to work very well.

Also as described herein, in certain embodiments, the conditions sufficient to form the corresponding crystalline two-dimensional transition metal carbide or metal nitride composition comprise heating the transition metal precursor, dispersed within a salt matrix, with the hydrocarbon or amine at a temperature in a range of from about 500° C. to about 550° C., from about 550° C. to about 600° C., from about 600° C. to about 650° C., from about 650° C. to about 700° C., from about 700° C. to about 750° C., from about 750° C. to about 800° C., from about 800° C. to about 850° C., from about 850° C. to about 900° C., or a combination of two or more of these ranges. As exemplified herein, where the transition metal precursors are dispersed within the salt matrices by slurrying the two materials together, for example in an alcohol or aqueous solution, as exemplified in the examples, the use of an intermediate temperature, for example in a range of from about 100° C., 150° C., or about 200° C. to about 350° C. or about 400° C., may be useful to dry the solids before the higher temperature reaction conditions. In certain embodiments, these higher temperatures (e.g. from about 500° C. to about 900° C.) may be held for times ranging from about 1 hour to about 2 hours, from about 2 hours to about 4 hours, from about 4 hours to about 8 hours, from about 8 hours to about 12 hours, or a combination of two or more of these ranges. The times and temperatures may affect the stoichiometry of the crystalline carbide or nitride compositions, as discussed in the Examples.

Once formed, the crystalline two-dimensional metal carbide or metal nitride compositions may be separated from the salt matrix, preferably by dissolving the salt of the salt matrix. This is most conveniently done by adding the cooled reaction mixture to a volume of excess water, typically resulting in the formation of suspension of dispersed crystalline two-dimensional metal carbide or metal nitride flakes. These flakes can be isolated by vacuum filtration (to form arrays of overlapping flakes) or centrifugation. The isolated flakes may be re-suspended into aqueous solutions, for example, aqueous electrolytes, for further manipulation.

While the present invention has been described in terms of methods for producing these 2D transition metal carbides or metal nitrides, as flakes or powders, the present invention also contemplates those structures comprising layered arrays of two-dimensional transition metal carbide or metal nitride flakes. While these flakes have been described as those prepared by the methods described herein, it should also be appreciated that these methods are conducive to preparing structures previously unavailable by other methods. Certain embodiments, then, provide those flakes or arrays of 2D transition metal carbides or transition metal nitrides which are not limited by the methods of making.

Still other embodiments also provide for electronic device or energy storage devices comprising a layered array of two-dimensional metal carbide or metal nitride flakes as described herein. Such devices may include, for example, energy storage devices, electrocatalysis devices, electromagnetic interference shielding coating and devices, and other applications that require high electronic conductivity, for example plasmonic devices. Such compositions and devices include the mixing with, preferably by intercalation by alkali metal salts, preferably sulfides. In preferred embodiments, the alkali metal sulfides comprise lithium ions, sodium ions, and/or potassium ions. In more preferred embodiments, the alkali metal sulfides are lithium sulfides, for example Li₂S or Li₂S₆.

### EXAMPLES

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

### Example 1: General Overview

Due to the recent demonstration of promising properties of transition metal nitride (TMN) nanomaterials in fields ranging from plasmonics to energy harvesting, conversion and storage, the research of TMN nanomaterials especially the development of new synthesis techniques and material applications, has attracted great attention. As a typical example, there are two major challenges remaining in the cathodes of lithium-sulfur (Li—S) batteries—full utilization of sulfur and strong affinity between host materials and sulfur species. Interestingly, TMNs have been validated to have a strong interaction with sulfur species, in contrast to widely studied carbon materials. Combined with high electrical conductivity, TMN nanomaterials can help alleviate challenges. However, it should be noted that the promising performance was mainly achieved on low areal sulfur loading (below 3 mg cm⁻²) previously, while reaching the high and stable capacity during long-term cycling (>500 cycles) are still challenging but highly demanded for high areal sulfur loading cathode. This is due to the fact that the structure and conductivity cannot be optimized simultaneously in conventional synthesis methods, which is also a common issue in many research fields.

In general, zero-dimensional (0D) nanoparticles with very high surface area can provide highly exposed active sites. However, electron transport severely decreases if there are only physical contacts between self-assembled nanocrystals. On the other hand, two-dimensional (2D) metallically conducting flakes can conduct electrons to the less conducting material at their surface. A restacked MXene film shows an excellent conductivity, up to 8000 S cm⁻¹. Nevertheless, such a dense film (3-4 g cm⁻³) is not favorable for ultrahigh rate ion transport. Designing a nanostructure that takes advantages of both 0D and 2D morphologies may enable conductivity and accessibility simultaneously. One can hypothesize that interconnected few-nanometer TMN nanocrystals with overall 2D morphology would be a promising candidate, providing both high surface area and good electron/ion transport.

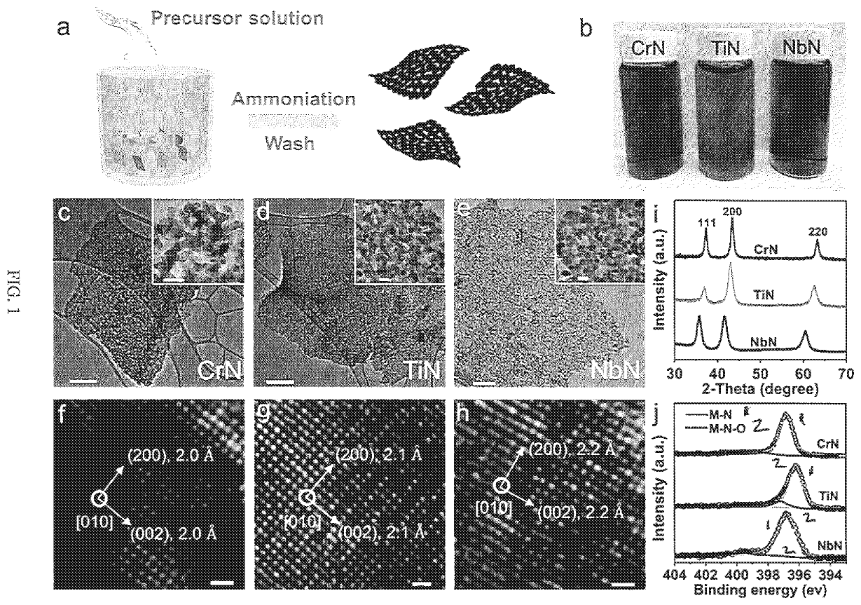

In this work, we report on synthesis of exemplary 2D arrays of few-nanometer TMN nanocrystals. Using topochemical synthesis, a thin layer of precursor on the surface of salt template was gradually transformed into TMN under a constant flow of ammonia. During ammoniation, the precursor was “etched” and recrystallized to form interconnected nanocrystals with few-nanometer size, arranged in unique 2D arrays. The schematic of synthesis is shown in FIG. 1A. Precursor-coated salts (labeled as precursor@salts) were first prepared by coating a precursor solution in ethanol onto the surface of the salt and drying at 70° C. in air.

Here, precursors that can be directly ammoniated were chosen, which include chromium chloride, titanium ethoxide and niobium ethoxide, to later yield chromium nitride, titanium nitride and niobium nitride, respectively. Each precursor@salt was heated separately under a constant flow of ammonia for 2 h and transformed into a TMN@salt with a blackish color.

With further washing of the salts in deionized water (DI water), 2D arrays of TMN nanocrystals could be separated and dispersed in solvents. Interestingly, although the color of concentrated solutions of various TMN nanocrystals are all black, their diluted colloidal solutions show different colors due to different electronic and optical properties of the produced nitrides. As shown in FIG. 1B, the colors are grayish, yellow-greenish and blackish for CrN, TiN and NbN, respectively.

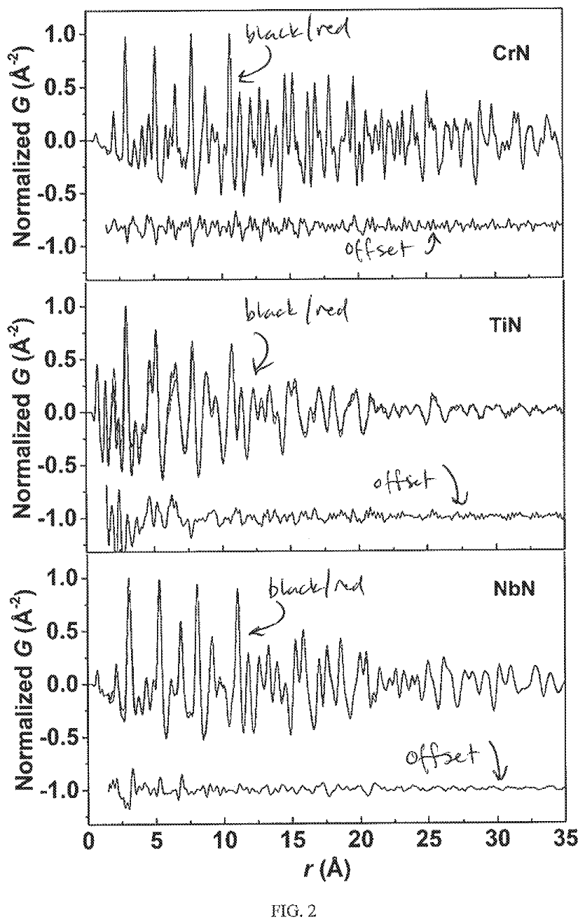

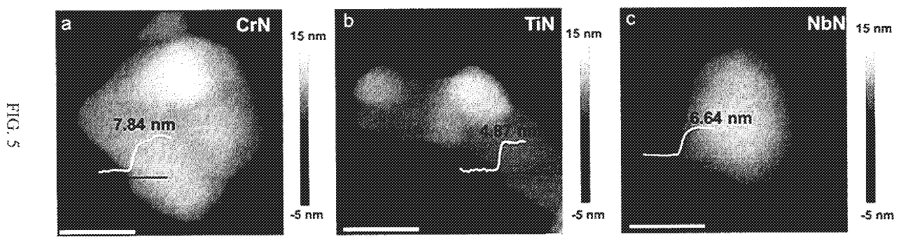

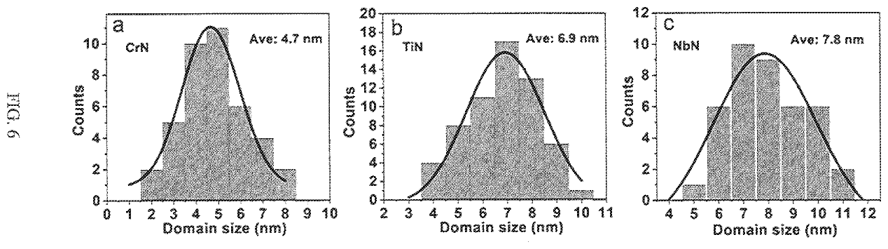

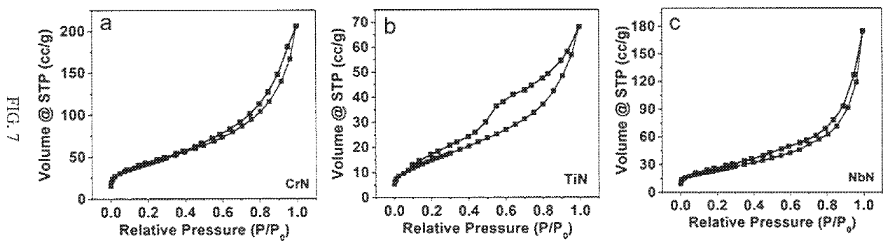

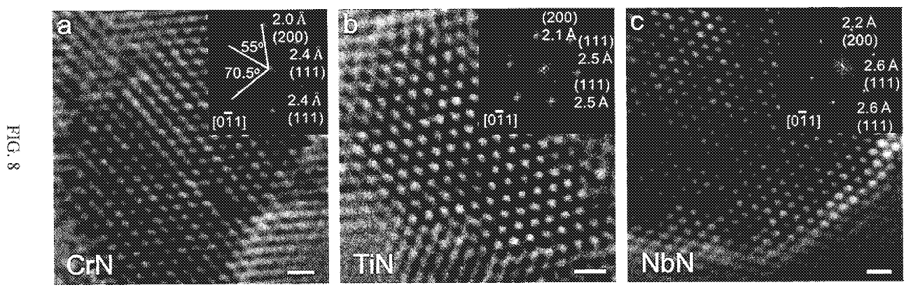

The morphologies of the TMN nanocrystals were investigated by transmission electron microscopy (TEM). As shown in FIGS. 2(C-E), the overall morphologies are ultrathin flakes with lateral sizes varying from hundreds of nanometers to a few microns. Through atomic force microscopy (AFM) measurements, the thicknesses are estimated to be between 4 to 8 nm (FIG. 5). Impressively, according to enlarged TEM images (insets of FIGS. 2(C-E)), these TMN flakes are actually “pseudo” 2D flakes consisting of many interconnected few-nanometer nanocrystals. Statistically, the average domain size of each CrN nanocrystal is 4.7 nm, which is the smallest among the three TMNs samples (FIG. 6), compared to 6.9 nm of TiN and 7.8 nm of NbN, respectively. This unique structure of 2D arrays of few-nanometer nanocrystals can provide more exposed active sites and allow ionic transport through the flakes due to the presence of pores between the nanocrystals. As shown in FIG. 7, the specific surface area (SSA) is estimated to be 153, 57, 88 m² g¹ for CrN, TiN and NbN, respectively.

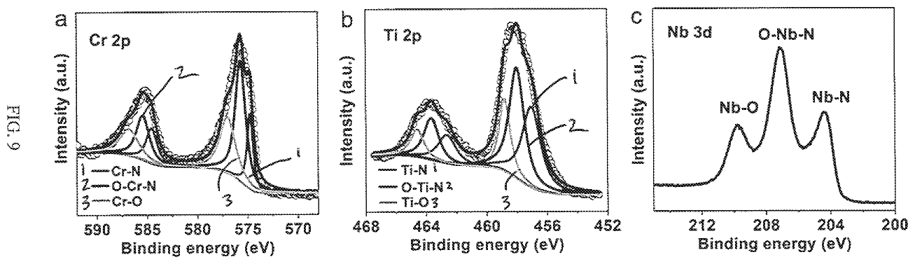

The microscopic crystal structure was first characterized by high-resolution TEM (HRTEM) as shown in FIGS. 1(F-H) and FIG. 5. Notably, all the few-nanometer nanocrystals are single-crystalline. Two identical d-spacings of 2.0 Å with an angle of 90° were shown in FIG. 1f, which is in accordance with the theoretical d-spacing values of (200) and (002) facets of CrN (PDF #03-065-2899) with a square symmetry on the [010] zone axis. The same square symmetries on the [010] zone axis were visualized for both TiN and NbN, with slightly larger d-spacing values of (200) and (002) facets as shown in FIGS. 1g and 1h (PDF #38-1420 and PDF #01-088-2404), which is possibly due to the larger atom sizes of Ti and Nb when compared to Cr. The crystal structures of three TMN nanocrystals were also demonstrated by X-ray diffraction (XRD). As shown in FIG. 1(I), three predominant peaks can be indexed to the cubic single-metal nitrides which is consistent with HRTEM analysis. In addition, the chemical composition of 2D arrays of TMN nanocrystals were probed by X-ray photoelectron spectroscopy (XPS). The predominant peaks in N is region (396.8 eV for CrN, 396.2 eV for TiN, and 396.8 eV for NbN) were assigned to metal-N bonding, confirming the formation of metal nitrides (FIG. 1(J)). Another small peak next to metal-N bonding was assigned to metal-N—O bonding, which can be further confirmed in the metal region as shown in FIG. 9. The existence of O should be attributed to the oxygen termination of TMN surface.

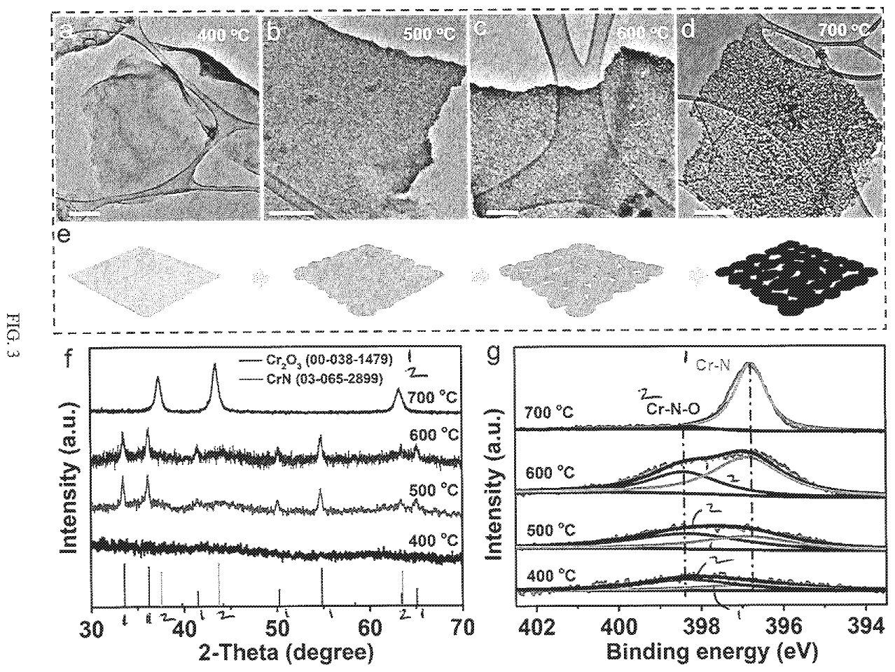

To obtain a more quantitative atomic structure of the materials, X-ray pair distribution function (PDF) analysis was performed on these 2D arrays of TMN nanocrystals. The PDF describes the probability of finding two atoms in a material at a distance r apart and can be used to model the local structure of nanocrystals. As shown in FIG. 3, after comparing the measured PDF results with PDF profiles computed from best-fit structural models, all three samples are shown to agree well with cubic TMN structures. Peaks in the PDF show interatomic bonding in the material. For instance, the first peaks around 2 Å in the three profiles further confirmed the presence of metal-N bonds. The cubic lattice parameters obtained after the structure refinement were 4.148 Å for CrN, 4.195 Å for TiN and 4.318 Å for NbN, respectively (See details in Table 1). In addition, the X-ray PDF analysis can provide more specific information on crystallinity. Significantly, although the XRD patterns of all the three samples are very similar, their local structure PDF profiles are different. The PDF peaks of CrN and NbN are very sharp, while those of TiN are broad. Furthermore, the PDF signal extended to ˜8 nm for CrN, 6 nm for NbN, but only to 3.5 nm for TiN. Both the broader peaks and narrower r-range where signal is seen indicate that CrN and NbN have a higher crystallinity and a much lower level of positional disorder than TiN. We believe this phenomenon can be attributed to higher reactive surface of low-dimensional TiN, and that a larger amount of oxygen-termination exists on the surface of 2D arrays of TiN than CrN and NbN, and maybe some oxygen dissolve in the lattice to form oxynitrides, resulting in lower structure ordering.

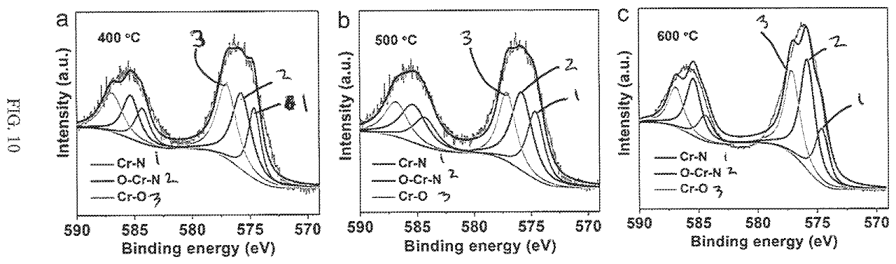

The growth mechanism of the 2D arrays of TMN nanocrystals was studied by comparing the morphology, crystal structure and chemical composition of samples ammoniated at different temperatures, but the same dwell time. Using CrN as an example, when ammoniating a precursor at 400° C., light green powders were obtained. A 2D nanosheet morphology, instead of 2D arrays of nanocrystals was achieved, as confirmed by TEM shown in FIG. 3(A). However, no obvious peaks were found in the XRD pattern (FIG. 3(F)) while Cr—O bonding was verified in XPS (FIG. 10), implying the formation of amorphous CrOₓ at this stage. Interestingly, two weak Cr—N and Cr—N—O bonding appeared in the N is region of XPS (FIG. 3(G)), demonstrating the beginning of ammoniation and partial oxygen substitution by nitrogen. When increasing the temperature to 500° C., 2D arrays started to appear, as shown in FIGS. 3(B&E). According to XRD pattern, all the peaks can be indexed to Cr₂O₃ (PDF #38-1479). Even though there is no phase of chromium nitride, the intensity of Cr—N bonding in XPS is enhanced, resulting from the further substitution of O by N (FIG. 3(G)). This trend is evident when the ammoniation temperature increased to 600° C. The XRD peaks were a little broader than in the pattern obtained at 500° C. (FIG. 3(F)), validating that the domain size of the nanocrystal has decreased, which is in agreement with TEM results (FIG. 3(C)). Although they are still 2D arrays of Cr₂O₃ (FIGS. 3(C&F)), the Cr—N bonding becomes predominant in the XPS spectrum (FIG. 3(G) and FIG. 10). Notably, the color of the sample treated at 600° C. changed from the typical greenish color of Cr₂O₃ to greyish. Finally, blackish powder was obtained after ammoniation at 700° C. At this stage, Cr₂O₃ was completely transformed to CrN, as confirmed by XRD (FIG. 3(F)). Combined with a very strong Cr—N bonding, the formation of 2D arrays of few-nanometer CrN nanocrystals has been verified (FIGS. 3(D&G)).

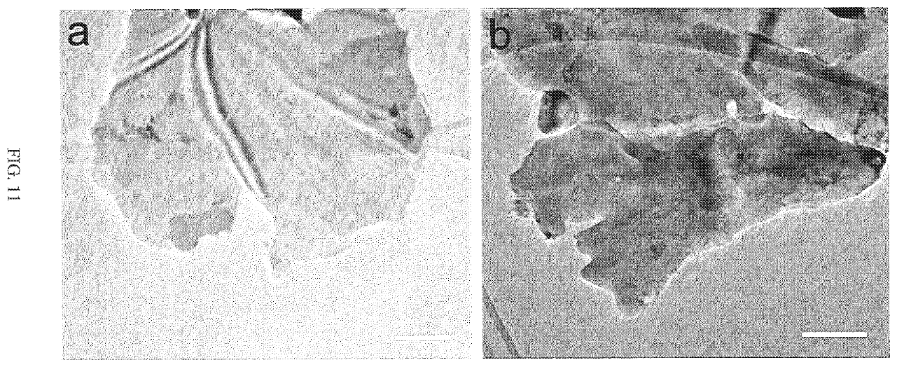

To summarize, the growth process of 2D arrays of TMN nanocrystals is a topochemical synthesis process. During the heating, ultrathin transition metal oxide (TMO) flakes were first generated. Meanwhile, O was topochemically substituted by N via ammoniation. Given the intense reaction occurred in pure anhydrous ammonia and the huge differences in crystal structures and volumes between TMOs and TMNs, TMOs flakes were “etched” and recrystallized to few-nanometer TMN nanocrystals while retaining the overall 2D morphology. Control experiments validated our assumption. As shown in FIG. 11, when annealing the precursor in air and Ar at 700° C., only layered nanosheets were obtained, demonstrating that the formation of 2D arrays of TMN nanocrystals occurred during ammoniation. These 2D arrays of few-nanometer TMN nanocrystals should be superior to self-assembled nanoparticles, in terms of the conductivity due to interconnected nanocrystals.

This may be favorable for applications requiring abundant active sites and high conductivity, such as electrochemical energy storage systems. As mentioned, TMNs have shown promising performance in Li—S batteries, but long-term stability and high areal sulfur loading still need to be addressed. An ideal sulfur cathode host for Li—S batteries should have the following characteristics: (i) strong surface affinity and high polar binding capability for polysulfides to suppress polysulfide shuttle effect; (ii) high specific surface area to ensure uniform dispersion of active sulfur and provide high-density exposed active sites for the chemical adsorption with polysulfides even at a high sulfur loading (>5 mg cm⁻²); (iii) high conductivity to endow an effective ion and electron pathway for long-term charge/discharge stability of the electrode at high current density. In our case, few-nanometer TMN nanocrystals can provide high surface area with strong affinity of polysulfides, which is favorable for fast ion diffusion and stable Li—S cathode at high sulfur loading. Moreover, 2D-like arrays of interconnected structure can assure fast electron transport in between nanocrystals.

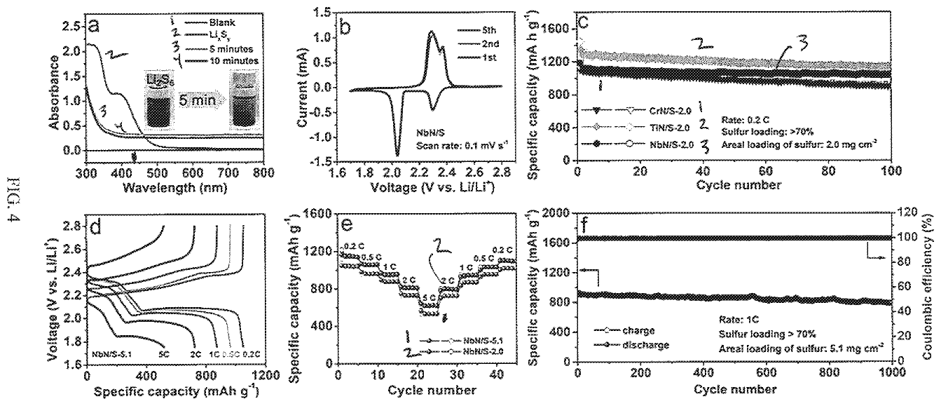

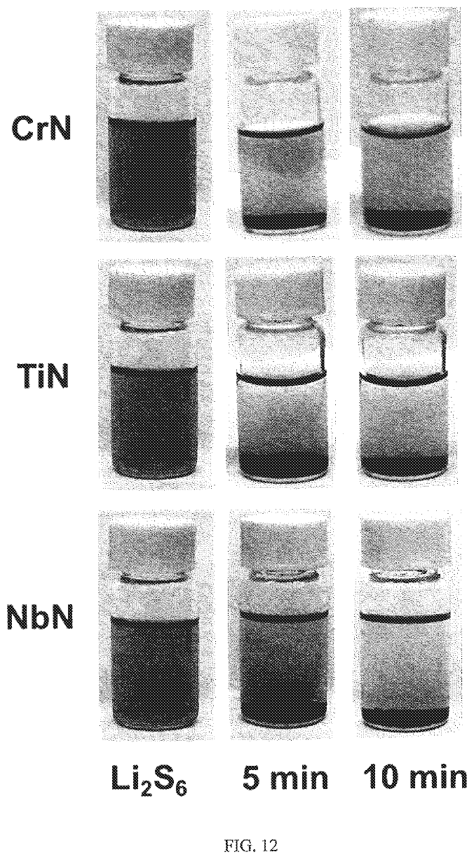

We first investigated their absorption ability of polysulfides (Li₂S₆) (see details in Methods). The strong surface affinity for polysulfides can be directly verified in optical images (the inset in FIG. 4(A) and FIG. 12). For example, 2D arrays of NbN could completely de-color the polysulfide solution within 5 minutes (20 mg of TMN nanocrystals powder was soaked in 10 mL of 5 mM Li₂S₆ solution at 25° C.), indicating fast and strong polysulfide adsorption capability. This result is consistent with the DFT results of the previous report. Ultraviolet/visible absorption measurements were conducted to probe the concentration changes of Li₂S₆ solutions as shown in FIG. 4(A). It can be seen from the static test that the absorption peak of Li₂S₆ in the visible light range (400 nm) disappeared after adding NbN powder for 5 minutes. Such a strong chemical interaction between TMN nanocrystals and polysulfides should be beneficial to restrain the polysulfide shuttle effect during long-term cycling.

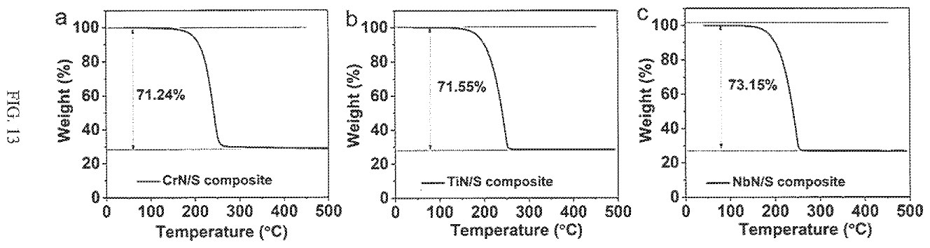

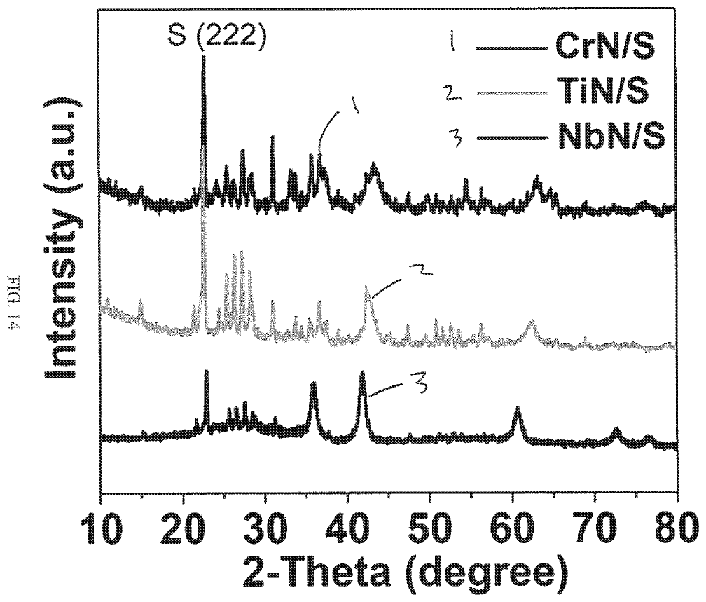

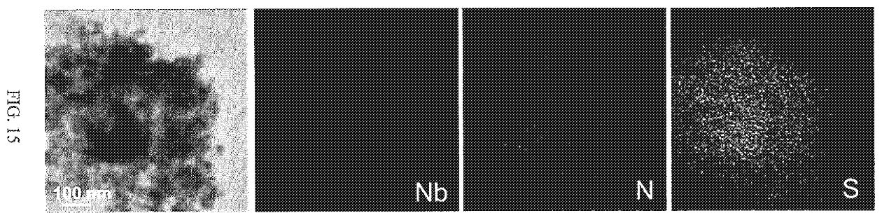

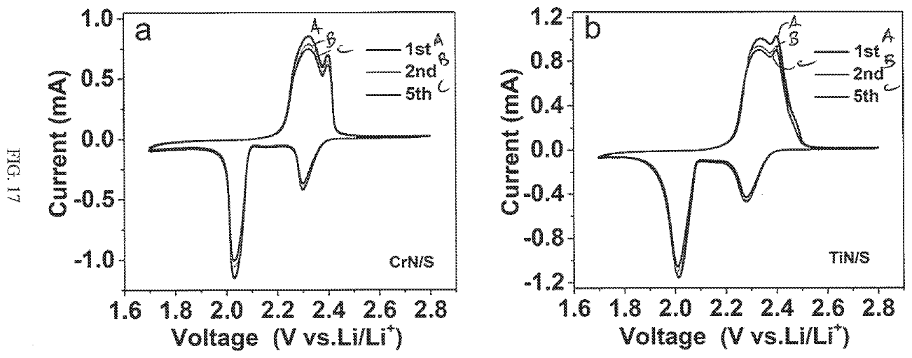

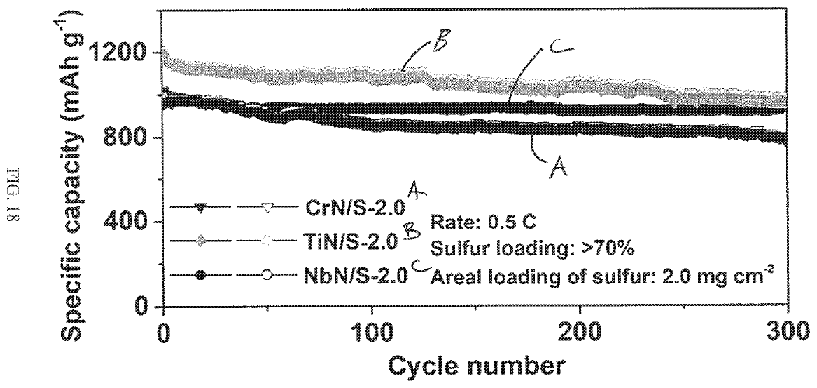

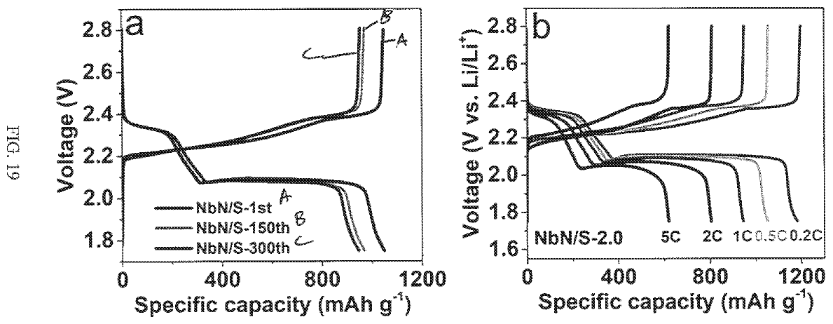

Accordingly, three TMN/S composites were fabricated by a melting diffusion method (see details in Methods). The sulfur loading percentages in all three composites are higher than 70 wt. % (NbN/S: 73.15 wt. %, TiN/S: 71.55 wt. % and CrN/S: 71.24 wt. %) as determined by thermogravimetric analysis (TGA, FIG. 13). The chemical compositions were confirmed by XRD, elemental mapping and XPS (see details in FIGS. 14-16). Firstly, the electrochemical performance of three composites was studied by assembling coin cell type batteries with areal sulfur loading of 2.0 mg cm⁻² (labelled as TMN/S-2.0). As shown in FIG. 4(B) and FIG. 17, two representative cathodic peaks can be found in the cyclic voltammetry (CV) curves with no obvious shift within the initial 5 cycles. These peaks are attributed to the formation of long-chain polysulfides (Li₂Sₓ, 4<x≤8) from S₈, and subsequently the formation of short-chain sulfides (Li₂S₂ and Li₂S), respectively. The anodic peaks demonstrated the reversible conversion. All the three electrodes showed high initial reversible capacities and NbN/S has the best cycling stability (FIG. 4(C), FIG. 18, Table 1). 93% of the reversible capacity of 1140 mAh g⁻¹ was retained after 100 cycles at 0.2 C. And when cycling at 0.5 C for 300 cycles, only 7.7% of capacity was lost and the voltage plateau shows no change (FIG. 19(A)). This cycling performance (0.026% degradation per cycle at 0.5 C) is among the best and superior to various transition metal oxide (TMO), TMN, and carbon-based cathodes with similar sulfur loading reported in literature (Table 2).

In practice, a higher areal sulfur loading (>5 mg cm²) is useful for Li—S batteries. In this context, we focused on the most stable NbN/S electrode and fabricated a higher areal sulfur loading electrode of 5.1 mg cm⁻² (labeled as NbN/S-5.1). As shown in FIG. 4(D) and FIG. 19(B), the NbN/S-5.1 electrode shows good rate performance and high Coulombic efficiency at scan rates ranging from 0.2 C to 5 C, similar to the NbN/S-2.0 electrode. It should be noted that NbN/S-5.1 is working well even at a high rate of 5 C, as the discharge plateau is still obvious and stable. Reversible and stable capacities of 1050 mAh g⁻¹, 979 mAh g⁻¹, 905 mAh g⁻¹, 745 mAh g⁻¹ and 560 mAh g⁻¹ are obtained at 0.2 C, 0.5 C, 1 C, 2 C and 5 C, respectively, which are only a bit lower than the capacities of NbN-2.0 electrodes without abrupt capacity degradation (FIG. 4(E)), demonstrating the excellent stability of the NbN-5.1 electrodes at different rates. Impressively, the NbN/S-5.1 electrode delivered an initial capacity of 912.8 mAh g⁻¹ and retained a high capacity of 796.5 mAh g⁻¹ (87.3%) with the stable capacity retention over 1000 cycles at 1 C (a slow degradation rate of 0.013% per cycle). To date, for most of the reported works, the long-term cycling test is generally carried out at a lower sulfur-loading due to the limited carbon-polysulfides or metal-polysulfides interaction interfaces in 0D, 1D and 2D sulfur hosts materials (such as CNT, graphene, TMOs and other TMNs). To the best of our knowledge, this high rate cycling performance of the NbN/S-5.1 electrode is the best among slurry-based cathodes and many self-supporting cathodes with similar sulfur loading. The detailed comparison is presented in Table 2.

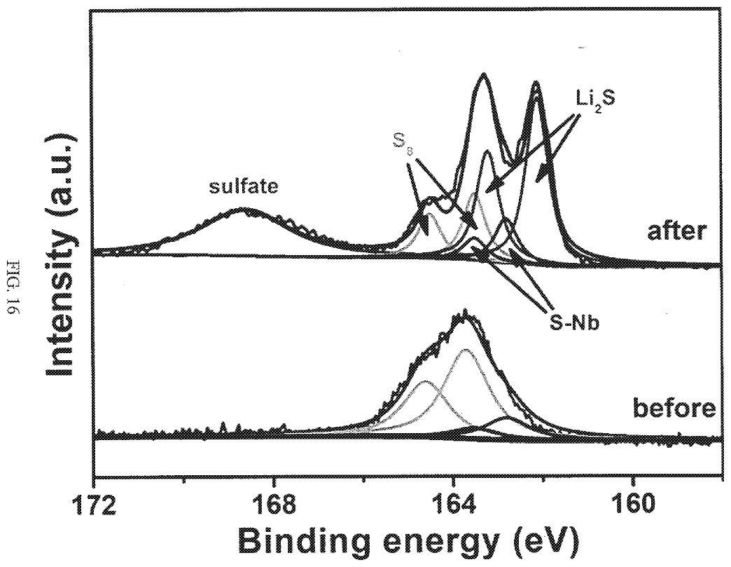

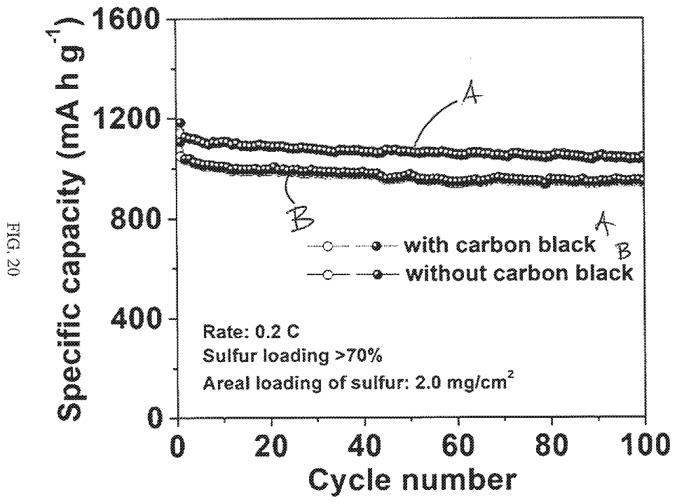

The performance of the high sulfur loading electrodes emphasizes the synergistic effect of high surface area, high-density active sites, inherently strong polysulfides affinity and high conductivity of the 2D arrays of TMN nanocrystals. The high specific surface area that resulted from the 2D arrays can keep the uniform distribution of large amounts of sulfur species, while strong interactions between them assures the stable trapping and reversible conversion of large amounts of polysulfides during long-term cycling. After several cycles, we checked the surface chemistry of a NbN/S electrode when discharged to 1.7 V. As shown in FIG. 16, compared to the initial NbN/S electrode, the predominant S is peak (162.1 eV) was Li₂S, which demonstrated the reversible electrochemical conversion process during the charge/discharge cycling. Combined with the fast ion and electron transport provided by the interconnected 2D arrays of TMN nanocrystals, high mass loading cathodes can work at high rates, showing high capacity during charge/discharge cycling. Interestingly, given the good conductivity of 2D arrays of TMN nanocrystals, we also fabricated a NbN/S electrode without carbon black conductive additive. As shown in FIG. 20, both capacity and stability are similar to the traditional electrode with carbon black, implying the total volumetric capacity may be further increased by eliminating traditional conductive additive.

In conclusion, we report a general approach to high-yield synthesis of interconnected 2D arrays of few-nanometer TMN nanocrystals. Based on systematic analysis, we propose that the growth mechanism is a topochemical process. Because of the reaction with ammonia and the differences in crystal structures and volumes of TMOs and TMNs, during the synthesis, the initially formed TMOs were etched and topochemically transformed to interconnected few-nanometer TMN nanocrystals while retaining a 2D-like morphology. Such a unique structure provides high surface area and high conductivity as demonstrated in Li—S batteries. Combined with inherently strong interactions with sulfur species, 2D arrays of NbN nanocrystals-based electrodes show an ultra-stable and high specific capacity during 1000 cycles under high areal sulfur loading, which may solve the issue of the polysulfide shuttle effect. With further understanding of the underlying growth process, 2D arrays of TMN or even transition metal carbide nanocrystals may be produced with versatile properties and applications beyond energy storage.

### Example 2. Materials and Methods

Example 2.1. Synthesis of 2D arrays of few-nanometer TMN nanocrystals. All chemicals were purchased from Sigma-Aldrich (USA). The 2D arrays of chromium nitride nanocrystals were synthesized in three steps. Firstly, chromium chloride coated sodium chloride (CrCl₂@NaCl) powders were prepared. Typically, 17 mg CrCl₂ powder was dissolved in 10 ml ethanol with stirring for 30 min on a magnetic stirrer or sonication for 5 min, forming the precursor solution, which was further mixed with 100 g NaCl powder and dried at 50° C. with stirring to obtain CrCl₂@NaCl. Secondly, the CrCl₂@NaCl was annealed at 700° C. for 2 hours at the ramp rate of 2° C./min under the constant flow of anhydrous NH₃. Finally, the product was washed with deionized water to remove NaCl and dispersed in deionized water. To obtain the powder of 2D arrays of chromium nitride, we vacuum-filtrated the dispersion on a membrane (Celgard) and dried the material in a vacuum oven at 70° C.

To produce 2D arrays of titanium nitride nanocrystals, firstly, titanium ethoxide coated potassium chloride (TiEX@KCl) powders were prepared. Typically, 20 μl titanium ethoxide was dissolved in 10 ml ethanol with stirring for 30 minutes on a magnetic stirrer or with sonication for 5 min, forming the precursor solution. The precursor solution was further mixed with 100 g KCl powder, and dried at 50° C. with stirring to obtain TiEX@KCl. Secondly, the TiEX@KCl was annealed at 750° C. for 2 hours at the ramp rate of 2° C./min under the constant flow of anhydrous NH₃. Finally, the product was washed by deionized water to remove KCl and dispersed in deionized water. To obtain the powder of 2D arrays of titanium nitride, we vacuum-filtrated the dispersion on a membrane (Celgard) and dried in vacuum oven at 70° C. for 12 h.

To produce 2D arrays of niobium nitride nanocrystals, niobium ethoxide coated potassium chloride (NbEX@KCl) powders were prepared. Typically, 14 μl niobium ethoxide was dissolved in 10 ml ethanol with stirring for 30 minutes on a magnetic stirrer or sonication for 5 min, forming the precursor solution. The precursor solution was further mixed with 100 g KCl powder, dried at 50° C. with stirring to obtain NbEX@KCl. Secondly, the NbEX@KCl was annealed at 750° C. for 2 hours at the ramp rate of 10° C./min under the constant flow of anhydrous NH₃. Finally, the product was washed by deionized water to remove KCl and dispersed in deionized water. To obtain the powder of 2D arrays of niobium nitride, we vacuum-filtrated the dispersion on a membrane and dried in vacuum oven at 70° C.

Example 2.2. Preparation of 2D arrays of TMN nanocrystals/sulfur composites. By a melting diffusion method, a mixture of 2D arrays of TMN nanocrystals and elemental sulfur (Sigma-Aldrich, >99%) (mass ratio=2.5:7.5) was quickly placed into a preheated horizontal furnace (at 155° C.) under ambient atmosphere for 20 hours, and then cooled down to room temperature.

Example 2.3. Preparation of Li₂S₆ solution. Li₂S₆ solution was prepared by dissolving Li₂S and elemental sulfur (with a stoichiometric ratio of 1:5) in a mixture of 1, 3-dioxolane (DOL) and 1, 2-dimethoxyethane (DME) (1:1 v/v) solvents.

Example 2.4. Electrochemical Measurements. Electrodes for lithium-sulfur batteries were fabricated by mixing 80 wt. % TMN/S composites, 10 wt. % carbon black (Super P, Sigma-Aldrich, 99%) and 10 wt. % Polyvinylidene fluoride (PVDF 6020, Sigma-Aldrich, 99%) in N-methyl-2-pyrrolidone (NMP, C₅H₉NO, Sigma-Aldrich, 99.5%) to form a slurry. Then, the slurry was spread onto an aluminum current collector (20 μm thickness) by a doctor blade. The electrode was dried under vacuum at 70° C. for 24 h. The area of cathode was 0.75 cm². The average sulfur loading mass on the “low” TMN/S composite electrodes were 2.0 mg/cm²; and a higher sulfur loading of 5.1 mg/cm² was also tested for NbN/S composite electrodes. Coin-type (CR2025) cells were assembled in a glove box (Mbraun, Unilab, Germany) in which oxygen and water contents were controlled to be less than 1 ppm.

Sulfur-containing electrodes were used as the cathode, lithium foil as the counter and reference electrode, which were electronically separated by a polypropylene membrane (3501 Coated PP, Celgard LLC, Charlotte, N.C.) saturated with an electrolyte. The electrolyte solution was 1.5 mol L⁻¹ lithium bis(trifluoromethane sulfonel)imide (LiTFSI, Sigma-Aldrich, 99.95%,) and 1 wt. % LiNO₃ (Sigma-Aldrich, ≥99%) in a solvent mixture of 1, 3-dioxolane (DOL, Sigma-Aldrich, ≥99%) and 1, 2-dimethoxyethane (DME, Sigma-Aldrich, ≥99%) (volume ratio 1:1) as the electrolyte. For each electrode, around 30 μL and 60 μL electrolyte was added in the coin cell for low and high sulfur loadings electrodes, respectively. Cyclic voltammetry (CV) and electrochemical impedance spectroscopy (EIS) measurements were conducted by using a VMP3 potentiostat (Biologic, France). CV tests were performed at a scan rate of 0.1 mV s⁻¹ in the voltage range of 1.7 to 2.8 V. The galvanostatic charge/discharge tests were carried out in the potential range of 1.7 to 2.8 V using an Arbin system (Arbin BT-2143-11U, College Station, Tex., USA). All experiments were conducted at room temperature.

Example 2.5. Characterization. Transmission electron microscopy (TEM) was performed using a JEM-2100 (JEOL, Japan) with an accelarating voltage of 200 kV. Surface area was analyzed by isothermal nitrogen gas adsorption at the liquid nitrogen temperature. Specific surface areas (SSA) were calculated by fitting the N₂ adsorption-desorption data using Brunauer-Emmett-Teller (BET) theory. Ultraviolet-visible (UV-vis) spectroscopy was performed from 300-800 nm using an Evolution 201 Spectrophotometer (ThermoFisher Scientific, USA) in a 10 mm path length quartz cuvette. After the addition of TMN to the Li₂S₆ solution, UV-vis spectra were collected after 5 and 10 minutes. Thermogravimetric analysis was performed on a Discovery SDT 650. The nitride powders were dried at 90° C. prior to the measurement to remove the solvents, and packed in a 90 μL alumina pan. Before heating, the analysis chamber was flushed with He gas at 100 mL/min for 1 h. The samples were heated to 500° C. at a constant heating rate of 10° C./min in He atmosphere (100 mL/min). Atomic force microscopy (AFM) was performed using Bruker Multimode 8 with a Si tip (Budget Sensors Tap300Al-G; f₀=300 kHz, k=40 N/m) in a standard tapping mode in air.

X-ray diffraction (XRD) was carried out using a Rigaku Smartlab (Tokyo, Japan) diffractometer with Cu-Kα radiation (40 kV and 44 mA) with a step scan 0.02°, a step time of 1 sand a 10×10 mm² window slit. X-ray photoelectron spectroscopy (XPS) spectra were measured by a spectrometer (Physical Electronics, VersaProbe 5000, Chanhassen, Minn.) employing a 100 μm monochromatic Al Kα x-ray beam to irradiate each sample's surface. Photoelectrons were collected by a takeoff angle of 180° between the sample surface of each sample and the path to the analyzer.

Charge neutralization was applied using a dual beam charge neutralizer irradiating low-energy electrons and ion beam to minimize the shift in the recorded BE. The x-ray total scattering experiments for pair distribution function (PDF) analysis were carried out at the beamline 28-ID-2 (XPD) at the National Synchrotron Light Source II (NSLS-II) at Brookhaven National Laboratory. The data were collected at room temperature using the rapid acquisition PDF method (RAPDF) (17). A large area 2D Perkin Elmer detector (2048×2048 pixels and 200×200 μm pixel size) was placed 201.12 mm behind the sample which was loaded in a 1 mm ID kapton capillary.

The incident wavelength of the x-ray was λ=0.1867 Å. Calibration of the experimental setup was done by measuring crystalline nickel as a standard material to calibrate the sample-to-detector distance and to determine the Q_{damp} and Q_{broad} parameters which are the parameters that correct the PDF envelope function for the instrument resolution (18, 19). The refined values Q_{damp}=0.035 Å⁻¹ and Q_{broad}=0.017 Å⁻¹ were fixed in the subsequent structural refinements of the PDF data.

TABLE 1
Structure refinement results of various
2D arrays of TMN nanocrystals.

| | cubic CrN | cubic TiN | cubic NbN |
|---|---|---|---|
| Phase | (Fm-3m) | (Fm-3m) | (Fm-3m) |
| R_{w} | 0.122 | 0.342 | 0.158 |
| a (Å) | 4.148 | 4.195 | 4.318 |
| b (Å) | 4.148 | 4.195 | 4.318 |
| c (Å) | 4.148 | 4.195 | 4.318 |
| Metal Uᵢₛₒ (Å) | 0.0060 | 0.0187 | 0.0128 |
| N Uᵢₛₒ (Å) | 0.0138 | 0.0176 | 0.0174 |
| δ₁ (Å) | 1.06 | 1.23 | 0.652 |
| SPD (Å) | 314.1 | 43.0 | 76.4 |

The atomic positions of the slab models were fixed during the refinement. Some parameters used in structure refinement have the following functionalities: Uᵢₛₒ (Å²) is the isotropic atomic displacement parameters (ADPs) of atoms; δ1 (Å) is correlated motion related linear/quadratic term coefficient; SPD is the sample particle diameter, or rather the coherent domain size of the sample, obtained from a shape damping function applied to the sample.

TABLE 2
Comparison of electrochemical performance of the reported transition metal oxide (TMO), transition
metal sulfide (TMS) and TMN self-supporting cathodes, and cathodes produced from slurries.

| | | | | | | Retained capacity |
|---|---|---|---|---|---|---|
| | S weight (wt. %) | | | Maximum | | (mA h gₛᵤₗ⁻¹), |
| | & areal S loading | Electrolyte | | discharge capacity | | Capacity retentions |
| | (mgₛᵤₗ cm⁻²) | amount | | (mA h gₛᵤₗ⁻¹) | | rate (%) |
| Carbon fiber paper | 72% & 1.5 | 40 | μL | 1170 | (0.2 C) | 856, 73% (200 |
| | 72% & 3.5 | | | 1080 | (0.2 C) | cycles, 0.2 C) |
| | 72% & 4.5 | | | 1005 | (0.2 C) | 782, 72% (200 |
| | | | | | | cycles, 0.2 C) |
| | | | | | | 680, 68% (200 |
| | | | | | | cycles, 0.2 C) |
| Carbon fiber | 72% & 3.6 | 40 | μL | 1215 | (0.2 C) | 950, 78% (200 |
| paper/RGO | | | | | | cycles, 0.2 C) |
| Rice derived | 76% & 2.0 | 40 | μL | 1340 | (0.2 C) | 820, 61% (500 |
| carbon/Ni | 76% & 4.0 | | | 891 | (0.05 C) | cycles, 0.2 C) |
| | | | | | | 563, 63% (200 |
| | | | | | | cycles, 0.2 C) |
| Ti₄O₇ | 60% & 2.6 | 40 | μL | 1070 | (0.5 C) | 950, 88% (200 |
| | | | | 850 | (2 C) | cycles, 0.2 C) |
| | | | | | | 595, 70% (500 |
| | | | | | | cycles, 2 C) |
| MnO₂ | 71% & 3.0 | 20 | μL mg⁻¹ | 1147 | (0.2 C) | 950, 82% (100 |
| | | | | 921 | (0.5 C) | cycles, 0.2 C) |
| | | | | | | 662, 71% (300 |
| | | | | | | cycles, 0.5 C) |
| YSC@Fe₃O₄ | 80% & 2.3 | 50 | μL mg⁻¹ | 1366 | (0.1 C) | 1160, 85% (200 |
| | | | | | | cycles, 0.1 C) |
| CO₉S₈ | 60% & 2.5 | 40 | μL | 1130 | (0.05 C) | 386,75% (400 |
| | | | | | | cycles, 2 C) |
| CoS₂(15%) + GO | 60% & 2.9 | 12 | μL | 1003 | (2 C) | 321, 32% (2000 |
| | | | | | | cycles, 2 C) |
| CO₃S₄ | 64% & 2.0 | 40 | μL | 1050 | (0.5 C) | 825, 78% (200 |
| | | | | 517 | (5 C) | cycles, 0.5 C) |
| | | | | | | 305, 51% (1000 |
| | | | | | | cycles, 5 C) |
| MoS₂₋ₓ (4%)/RGO | 60% & 2.0 | 27 | μL mg⁻¹ | 1156 | (0.5 C) | 628, 54% (600 |
| | | | | 826 | (8 C) | cycles, 0.5 C) |
| FeS₂(10%) | 60% & 2.0 | N/A | | 1129 | (0.5 mA cm⁻²) | 700, 62% (200 |
| | | | | | | cycles, 0.5 mA cm⁻²) |
| Co₄N | 49% & 1.5-2 | 40 | μL | 1659 | (0.1 C) | 1000, 60% (100 |
| (28%) | 63% & 2.4-2.8 | | | 900 | (2 C) | cycles, 0.1 C) |
| | 67% & 2.4-2.8 | | | 843 | (2 C) | 434, 48% (800 |
| | | | | | | cycles, 2 C) |
| | | | | | | 361, 43% (800 |
| | | | | | | cycles, 2 C) |
| TiN | 51% & 1.0 | 40 | μL | 988 | (0.5 C) | 644, 65% (500 |
| | | | | | | cycles, 0.5 C) |
| VN-NBs | 78.2% & 1.2 | 40 | μL | 1150 | (1 C) | 874, 74% (1000 |
| | 78.2% & 6.8 | | | 800 | (0.5 C) | cycles, 1 C) |
| | | | | | | 563, 68% (200 |
| | | | | | | cycles, 0.5 C) |
| VN (30%)/GO | 60% & 3.0 | 60 | μL | 1471 | (0.2 C) | 1252, 85% (100 |
| | | | | 1131 | (1 C) | cycles, 0.2 C) |
| | | | | | | 917, 81% (200 |
| | | | | | | cycles, 1 C) |
| CNT (10%)-Ti₂C | 66.4% & 1.5 | 40 | μL | 1240 | (0.05 C) | 450, 48.4% (1200 |
| | 64% & 5.5 | | | 910 | (0.2 C) | cycles, 0.5 C) |
| | | | | | | 512, 56.3% (250 |
| | | | | | | cycles, 0.2 C) |
| NbN | 73.15% & 2.0 | 30 | μL | 1140 | (0.2 C) | 1060, 93.0% (100 |
| TiN | 73.15% & 5.1 | 60 | μL | 1031 | (0.5 C) | cycles, 0.2 C) |
| CrN | 71.55% & 2.0 | 30 | μL | 913 | (1 C) | 952, 92.3% (300 |
| | 71.24% & 2.0 | 30 | μL | 1345 | (0.2 C) | cycles, 0.5 C) |
| | | | | 1200 | (0.5 C) | 797, 87.3% (1000 |
| | | | | 1105 | (0.2 C) | cycles, 1 C) |
| | | | | 998 | (0.5 C) | 1180, 87.7% (100 |
| | | | | | | cycles, 0.2 C) |
| | | | | | | 965, 80.4% (300 |
| | | | | | | cycles, 0.5 C) |
| | | | | | | 952, 86.5% (100 |
| | | | | | | cycles, 0.2 C) |
| | | | | | | 820, 82.2% (300 |
| | | | | | | cycles, 0.5 C) |

Additional Disclosure

Li-metal-anode is considered as the ultimate choice for Li-battery due to its high theoretical capacity (3680 mAh/g) and low redox potential (−3.04 V). Despite many advantages, Li-metal-anode are plagued with several practical issues, such as uncontrollable dendrite growth during Li plating/stripping process. This may result in short-circuit of the cell along with safety issues. To tackle these issues, electrodeposition of Li into conducting framework is an effective way. Transition metal carbides and nitrides nanocrystals are very promising materials as the framework for Li deposition due to the high electron conductivity and lithiophilicity.

One can use two-dimensional (2D) arrays of transition metal nitrides and carbides nanocrystals as the conducting framework for Li deposition, realizing highly stable Li-metal-anode. The 2D arrays of metal nitrides and carbides include 2D arrays of CrN, TiN, NbN, Cr₂C, and other metal carbides and metal nitrides. The disclosed technology allows one to fabricate stable Li-metal-anodes for a practical high energy Li-battery.

The following are exemplary, non-limiting synthesis processes.

Synthesis of 2D Arrays of Chromium Nitride Nanocrystals

2D arrays of chromium nitride nanocrystals were synthesized. Firstly, chromium chloride coated sodium chloride (NaCl@CrCl₂) powders were prepared. Typically, 17 mg CrCl₂ powder was dissolved in 10 ml ethanol with stirring for 30 minutes on a magnetic stirrer or sonication for 5 min, forming precursor solution. The precursor solution was further mixed with 100 g NaCl powder, drying at 50° C. with stirring to obtain NaCl@CrCl₂. It should be understood that essentially any metal halide can be used; the foregoing metal chlorides are illustrative only.

Secondly, the NaCl@CrCl₂ was annealed at 700° C. for 2 hours at a ramp rate of 10° C./min under the NH₃ atmosphere. Finally, the product was washed by deionized water to remove NaCl and dispersed in deionized water. To obtain a powder of 2D arrays of chromium nitride, one can vacuum-filtrate the dispersion to membrane and dry in vacuum oven at 70° C.

Synthesis of 2D Arrays of Titanium Nitride Nanocrystals

2D arrays of titanium nitride nanocrystals were synthesized. Firstly, titanium ethoxide coated potassium chloride (KCl@TiEX) powders were prepared. Typically, 20 μl titanium ethoxide was dissolved in 10 ml ethanol with stirring for 30 minutes on a magnetic stirrer or sonication for 5 min, forming precursor solution. The precursor solution was further mixed with 100 g KCl powder, drying at 50° C. with stirring to obtain KCl@TiEX. Secondly, the KCl@TiEX was annealed at 750° C. for 2 hours at the ramp rate of 10° C./min under the NH₃ atmosphere. Finally, the product was washed by deionized water to remove KCl and dispersed in deionized water. To obtain the powder of 2D arrays of titanium nitride, one can vacuum-filtrate the dispersion to membrane and dry in vacuum oven at 70° C.

Synthesis of 2D Arrays of Niobium Nitride Nanocrystals

2D arrays of niobium nitride nanocrystals were synthesized by three steps. Firstly, niobium ethoxide coated potassium chloride (KCl@NbEX) powders were prepared. Typically, 14 μl niobium ethoxide was dissolved in 10 ml ethanol with stirring for 30 minutes on a magnetic stirrer or sonication for 5 min, forming precursor solution. The precursor solution was further mixed with 100 g KCl powder, drying at 50° C. with stirring to obtain KCl@NbEX. Secondly, the KCl@NbEX was annealed at 750° C. for 2 hours at the ramp rate of 10° C./min under the NH₃ atmosphere. Finally, the product was washed by deionized water to remove KCl and dispersed in deionized water. To obtain the powder of 2D arrays of niobium nitride, we can vacuum-filtrate the dispersion to membrane and dry in vacuum oven at 70° C.

Synthesis of 2D Arrays of Chromium Carbide Nanocrystals

2D arrays of chromium carbide nanocrystals were synthesized by three steps. Firstly, chromium chloride coated sodium chloride (NaCl@CrCl₂) powders were prepared. Typically, 17 mg CrCl₂ powder was dissolved in 10 ml ethanol with stirring for 30 minutes on a magnetic stirrer or sonication for 5 min, forming precursor solution. The precursor solution was further mixed with 100 g NaCl powder, drying at 50° C. with stirring to obtain NaCl@CrCl₂. Secondly, the NaCl@CrCl₂ was annealed at 700° C. for 2 hours at the ramp rate of 10° C./min under the CH₄ atmosphere. Finally, the product was washed by deionized water to remove NaCl and dispersed in deionized water. To obtain the powder of 2D arrays of chromium carbide, one can vacuum-filtrate the dispersion to membrane and dry in vacuum oven at 70° C.

Synthesis of 2D Arrays of Titanium Carbide Nanocrystals

2D arrays of titanium carbide nanocrystals were synthesized by three steps. Firstly, titanium ethoxide coated potassium chloride (KCl@TiEX) powders were prepared. Typically, 20 μl titanium ethoxide was dissolved in 10 ml ethanol with stirring for 30 minutes on a magnetic stirrer or sonication for 5 min, forming precursor solution. The precursor solution was further mixed with 100 g KCl powder, drying at 50° C. with stirring to obtain KCl@TiEX. Secondly, the KCl@TiEX was annealed at 750° C. for 2 hours at the ramp rate of 10° C./min under the CH₄ atmosphere. Finally, the product was washed by deionized water to remove KCl and dispersed in deionized water. To obtain the powder of 2D arrays of titanium carbide, we can vacuum-filtrate the dispersion to membrane and dry in vacuum oven at 70° C.

Synthesis of 2D Arrays of Niobium Carbide Nanocrystals

The 2D arrays of niobium carbide nanocrystals were synthesized by three steps. Firstly, niobium ethoxide coated potassium chloride (KCl@NbEX) powders were prepared. Typically, 14 μl niobium ethoxide was dissolved in 10 ml ethanol with stirring for 30 minutes on a magnetic stirrer or sonication for 5 min, forming precursor solution. The precursor solution was further mixed with 100 g KCl powder, drying at 50° C. with stirring to obtain KCl@NbEX. Secondly, the KCl@NbEX was annealed at 750° C. for 2 hours at the ramp rate of 10° C./min under the CH₄ atmosphere. Finally, the product was washed by deionized water to remove KCl and dispersed in deionized water. To obtain the powder of 2D arrays of niobium carbide, we can vacuum-filtrate the dispersion to membrane and dry in vacuum oven at 70° C.

Fabrication of Freestanding Film for Li-Metal-Anode

To fabricate a freestanding film for a Li-metal-anode. 2D arrays of transition metal nitrides and carbides nanocrystals were mixed with Ti₃C₂ MXene as the conductive binder. (It should be understood that the Ti₃C₂ MXene used is illustrative only, and essentially any other MXene material can be used.)

The Ti₃C₂Tₓ was prepared by HCl—LiF method as reported elsewhere. Ti₃C₂ MXene was dropped into the solution of 2D arrays of transition metal nitrides and carbides nanocrystals, followed by sonication for 1 minute or shaking for 5 minutes. Then, the mixed solution was filtered through Celgard membrane via vacuum-assisted filtration. A freestanding film can be peeled off the membrane when almost dry.

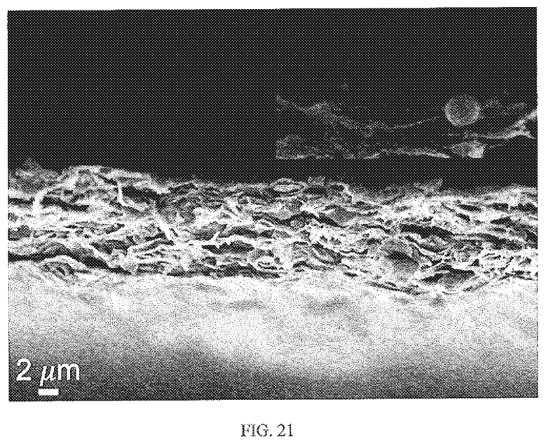

The electrode was further dried under vacuum at 70° C. for 24 h. The weight ratio of 2D arrays of metal nitrides and carbides nanocrystals and Ti₃C₂ MXene was tuned as 30:70, 50:50, 70:30, and 90:10, respectively. According to the cross-sectional scanning electron microscopy (SEM) image (FIG. 21), the freestanding film consisted of layered nanosheets, and the thickness of films is around 8 μm.

To test the long-term stability during Li plating/stripping process, coin-type (CR2032) cells were assembled in a glove box in which oxygen and water contents were controlled to be less than 1 ppm. Freestanding films were used as the cathode, lithium foil as the counter and reference electrode, which were electronically separated by a polypropylene (Celgard) membrane saturated with an electrolyte. The electrolyte solution was 1.5 mol L⁻¹ lithium bis(trifluoromethane sulfonel)imide (LiTFSI) and 1 wt. % LiNO₃ in a solvent mixture of 1, 3-dioxolane (DOL) and 1, 2-dimethoxyethane (DME) (volume ratio 1:1) as the electrolyte. For each electrode, around 30 μL electrolyte was added in the coin.

Using 2D arrays of NbN nanocrystals as an example, we tested the cycling stability of NbN/Ti₃C₂ freestanding films with different ratios (NbN-number means the weight percentage of NbN in film). As shown in FIG. 22, NbN-90 showed the most stable cycling performance, and the Coulombic Efficiency was more than 99% after 500 cycles, which is the one of the best performances in the reported literatures.

### SUMMARY

Provided are 2D arrays of transition metal nitrides and carbides nanocrystals, which arrays provide a superior conducting framework for Li deposition, largely suppressing the uncontrollable Li dendrite growth as Li-metal-anode during cycling. This technology in turn enables the development of practical Li-batteries, and have application in various energy storage system and beyond.

### REFERENCES

The following reference are incorporated herein by reference in their entireties for any and all purposes.
W. Zhou, B. Guo, H. Gao, J. B. Goodenough, Low-cost higher loading of a sulfur cathode. Adv. Energy Mater. 6, 1502059 (2016).
Z. Li, J. T. Zhang, Y. M. Chen, J. Li, X. W. Lou, Pie-like electrode design for high-energy density lithium-sulfur batteries. Nat. Commun. 6, 8850 (2015)
Y. Zhong, X. Xia, S. Deng, J. Zhan, R. Fang, Y. Xia, X. Wang, Q. Zhang, J. Tu, Popcorn inspired porous macrocellular carbon: rapid puffing fabrication from rice and its applications in lithium-sulfur batteries. Adv. Energy Mater. 8, 1701110 (2018).
Z. Li, J. Zhang, X. W. Lou, Hollow carbon nanofibers filled with mno₂ nanosheets as efficient sulfur hosts for lithium-sulfur batteries. Angew. Chem. Int. Ed. 54, 12886-12890 (2015).
Q. Pang, D. Kundu, L. F. Nazar, A graphene-like metallic cathode host for long-life and high-loading lithium-sulfur batteries. Mater. Horiz. 3, 130-136 (2016).
Z. Yuan, H. J. Peng, T. Z. Hou, J. Q. Huang, C. M. Chen, D. W. Wang, X. B. Cheng, F. Wei, Q. Zhang, Powering lithium-sulfur battery performance by propelling polysulfide redox at sulfiphilic hosts. Nano Lett. 16, 529-527 (2016).
41. J. Pu, Z. Shen, J. Zheng, W. Wu, C. Zhu, Q. Zhou, H. Zhang, F. Pan, Multifunctional Co₃S₄@ sulfur nanotubes for enhanced lithium-sulfur battery performance. Nano Energy 37, 7-14 (2017).
T. Chen, Z. Zhang, B. Cheng, R. Chen, Y. Hu, L. Ma, G. Zhu, J. Liu, Z. Jin, Self-templated formation of interlaced carbon nanotubes threaded hollow co₃S₄ nanoboxes for high-rate and heat-resistant lithium-sulfur batteries. J. Am. Chem. Soc. 139, 12710-12715 (2017).
S. S. Zhang, D. T. Tran, Pyrite FeS₂ as an efficient adsorbent of lithium polysulphide for improved lithium-sulphur batteries. J. Mater. Chem. A 4, 4371-4374 (2016).
D. R. Deng, F. Xue, Y. J. Jia, J. C. Ye, C. D. Bai, M. S. Zheng, Q. F. Dong, Co₄N nanosheet assembled mesoporous sphere as a matrix for ultrahigh sulfur content lithium-sulfur batteries. ACS Nano 11, 6031-6039 (2017).
X. Liang, Y. Rangom, C. Y. Kwok, Q. Pang, L. F. Nazar, Interwoven MXene nanosheet/carbon-nanotube composites as li-s cathode hosts. Adv. Mater. 29, 1603040 (2017).
Gogotsi, Y. G.; Andrievski, R. A. (Eds.), Materials Science of Carbides, Nitrides and Borides, NATO Science Series (Kluwer, Dordrecht, N L 1999).
Naik, G. V. et al. Titanium nitride as a plasmonic material for visible and near-infrared wavelengths. Opt. Mater. Express 2, 478-489 (2012).
Alhabeb, M. et al. Guidelines for Synthesis and Processing of Two-Dimensional Titanium Carbide (Ti₃C₂Tₓ MXene). Chem. Mater. 29, 7633-7644 (2017).
Liang, X. et al. A facile Surface Chemistry Route to a Stabilized Lithium Metal Anode. Nat. Energy. 2 17119 (2017).
Xiao X., et al., Two-Dimensional Arrays of Transition Metal Nitride Nanocrystals, Adv. Materials, Vol. 31, Issue 33 (2019).

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

Each patent, patent application, and publication cited or described in this document is hereby incorporated herein by reference, each in its entirety, for all purposes, or at least for the context in which it was raised.

### EMBODIMENTS

The following embodiments are illustrative only and do not limit the scope of the present disclosure or the appended claims

Embodiment 1. A method of preparing a crystalline two-dimensional transition metal composition, comprising: reacting a transition metal precursor, dispersed within a crystalline salt matrix, with an amine, in an otherwise non-oxidative or inert environment, for a time and under conditions sufficient so as to form the corresponding two-dimensional transition metal nitride, admixed in the crystalline salt matrix, wherein the transition metal precursor optionally comprises at least one transition metal of Group 4 to 6 of the Periodic Table.

Embodiment 2. A method of preparing a crystalline two-dimensional transition metal composition, comprising: reacting a transition metal precursor, dispersed within a crystalline salt matrix, with a carbonaceous material, in an otherwise non-oxidative or inert environment, for a time and under conditions sufficient so as to form the corresponding two-dimensional transition metal carbide, admixed in the crystalline salt matrix, wherein the transition metal precursor optionally comprises at least one transition metal of Group 4 to 6 of the Periodic Table.

Embodiment 3. The method of any one of Embodiments 1-2, wherein the transition metal precursor comprises at least one of Cr, Nb, or Ti.

Embodiment 4. The method of any one of Embodiments 1-3, wherein the transition metal precursor further comprises an alkoxide, preferably a C1-3 alkoxide, an aryloxide, a halide, preferably chloride, nitrate, or sulfate.

Embodiment 5. The method of any one of Embodiments 1-4, wherein the crystalline salt matrix is a crystalline alkali metal halide, an alkaline earth metal halide, an alkali metal nitrate, an alkaline earth metal nitrate, an alkali metal sulfate, an alkaline earth metal sulfate, or a combination thereof, preferably CaCl₂), NaCl, KCl, NaNO₃, KNO₃, Na₂SO₄, K₂SO₄, MgSO₄, or a combination thereof.

Embodiment 6. The method of any one of Embodiments 1 or 3-5, wherein the amine is ammonia, methyl amine, ethyl amine, propyl amine, cyanoamine, cyanamide, cyanourea, melamine, dicyandiamide, or a combination thereof, more preferably ammonia.

Embodiment 7. The method of any one of Embodiments 2-5, wherein the carbonaceous material is methane, propane, butane, pentane, hexane, or any combination thereof, more preferably methane.

Embodiment 8. The method of any one of Embodiments 1-7, wherein the reacting of the transition metal precursor, dispersed within a crystalline salt matrix is in a range of from 350° C. to 850° C.

Embodiment 9. The method of Embodiment 1, wherein the admixed two-dimensional transition metal nitride and the crystalline salt matrix, is separated by dissolving the crystalline salt in an aqueous solution.

Embodiment 10. The method of Embodiment 2, wherein the admixed two-dimensional transition metal carbide and the crystalline salt matrix, is separated by dissolving the crystalline salt in an aqueous solution.

Embodiment 11. The method of any one of Embodiments 1 to 10, wherein the transition metal precursor, dispersed within a crystalline salt matrix, is prepared is prepared by coating the crystalline salt with a solution or suspension, preferably an alcoholic solution, of the transition metal precursor, and removing the solvent from the solution or suspension.

Embodiment 12. The method of any one of Embodiments 1 to 11, wherein the transition metal precursor is non-crystalline.

Embodiment 13. The method of any one of Embodiments 1 to 12, wherein the non-oxidative or inert environment is substantially free of oxidizable species, such as air or oxygen, where substantially free refers to the absence of oxidizable species sufficient to compromise the reactivity of the amine or the integrity of the corresponding two-dimensional transition metal nitride.

Embodiment 14. The method of any one of Embodiments 1 to 13, wherein the non-oxidative or inert environment comprises the use of nitrogen, argon, or other gas that is non-reactive under the reaction conditions, and the use of a crystallizing salt that is non-reactive under the reaction conditions.

Embodiment 15. The method of any one of Embodiments 1 to 14, wherein the weight ratio of the transition metal precursor to the salt is in a range of from about 1:1 to about 1:10, from about 1:10 to about 1:100, from about 1:100 to about 1:500, from about 1:500 to about 1:1000, from about 1:1000 to about 1:2500, from about 1:2500 to about 1:5000, or a combination of two or more of these ranges.

Embodiment 16. The method of Embodiment 1, further comprising separating the corresponding crystalline two-dimensional metal nitride composition from the salt matrix, preferably by dissolving the salt of the salt matrix in a second solvent so as to provide a suspension of dispersed crystalline two-dimensional metal nitride in the second solvent, present as flakes, and preferably isolating the two-dimensional metal nitride flakes by filtration or centrifugation.

Embodiment 17. The method of Embodiment 2, further comprising separating the corresponding crystalline two-dimensional metal carbide composition from the salt matrix, preferably by dissolving the salt of the salt matrix in a second solvent so as to provide a suspension of dispersed crystalline two-dimensional metal carbide in the second solvent, present as flakes, and preferably isolating the two-dimensional metal carbide flakes by filtration or centrifugation.

Embodiment 18. A composition comprising a layered array of crystalline two-dimensional metal nitride, present as flakes, said flakes prepared by or preparable by the method of any one of Embodiments 1, 3-6, or 8-16.

Embodiment 19. A composition comprising a layered array of crystalline two-dimensional metal carbide, present as flakes, said flakes prepared by or preparable by the method of any one of Embodiments 2, 3-5, or 7-16.

Embodiment 20. The composition of Embodiment 18, wherein the layered array of crystalline two-dimensional metal nitride further comprises an alkali metal sulfide, preferably present as layers intercalated in the layered array of crystalline two-dimensional metal nitride.

Embodiment 21. The composition of Embodiment 20, wherein the alkali metal sulfide is a lithium, sodium, or potassium sulfide, preferably a lithium sulfide, more preferably Li₂S or Li₂S₆.

Embodiment 22. The composition of Embodiment 19, wherein the layered array of crystalline two-dimensional metal carbide further comprises an alkali metal sulfide, preferably present as layers intercalated in the layered array of crystalline two-dimensional metal carbide.

Embodiment 23. The composition of Embodiment 22, wherein the alkali metal sulfide is a lithium, sodium, or potassium sulfide, preferably a lithium sulfide, more preferably Li₂S or Li₂S₆.

Embodiment 24. An electronic device comprising a composition of any one of Embodiments 18-23, wherein the electronic device is preferably an energy storage device, more preferably a battery, or a device useful for electrocatalysis, electromagnetic interference shielding or other applications that require high electronic conductivity

Embodiment 25. A composition or electronic device according to any one of Embodiments 18-23, characterized in a manner as described herein.

Embodiment 26. A composition, comprising: a layered array of crystalline two-dimensional transition metal nitride or a layered array of crystalline two-dimensional transition metal carbide, optionally present as flakes.

Embodiment 27. The composition of Embodiment 26, wherein the layered array of crystalline two-dimensional metal nitride or transitional metal carbide further comprises an alkali metal sulfide, preferably present as layers intercalated in the layered array of crystalline two-dimensional transition metal nitride or transition metal carbide.

Embodiment 28. The composition of Embodiment 27, wherein the alkali metal sulfide is a lithium, sodium, or potassium sulfide, preferably a lithium sulfide, more preferably Li₂S or Li₂S₆.

Embodiment 29. The composition of Embodiment 26, wherein the composition is characterized as an anode in an electrical cell or as a cathode in an electrical cell.

Embodiment 30. The composition of any one of Embodiments 26-29, further comprising an amount of a MXene material.

Embodiment 31. The composition of any one of Embodiments 26-30, wherein the composition comprises one or more of CrN, TiN, NbN, and Cr₂C.

Embodiment 32. The composition of any one of Embodiments 26-31, wherein the composition is characterized as a freestanding film.

Embodiment 33. The composition of any one of Embodiments 26-32, further comprising an amount of lithium disposed therein.

Embodiment 34. An electrical cell, comprising a cathode comprising the composition of any one of Embodiments 26-33 and further comprising an electrode that comprises lithium.

Embodiment 35. A battery, comprising: a cathode, the cathode comprising an amount of two-dimensional transition metal carbide and/or transition metal nitride, and an amount of sulfide or sulfur, the cathode further optionally comprising an amount of a MXene material; an anode, the anode comprising an amount of two-dimensional transition metal carbide and/or transition metal nitride, and an amount of lithium, the anode further optionally comprising an amount of a MXene material.

1. A method of preparing a crystalline two-dimensional transition metal composition, comprising:
reacting a transition metal precursor, dispersed within a crystalline salt matrix, with an amine or a carbonaceous material, in an otherwise non-oxidative or inert environment, for a time and under conditions sufficient so as to form the corresponding two-dimensional transition metal nitride, admixed in the crystalline salt matrix, wherein the transition metal precursor optionally comprises at least one transition metal of Group 4 to 6 of the Periodic Table.

2. (canceled)

3. The method of claim 1, wherein the transition metal precursor comprises at least one of Cr, Nb, or Ti.

4. The method of claim 1, wherein the transition metal precursor further comprises an alkoxide, preferably a C₁₋₃ alkoxide, an aryloxide, a halide, preferably chloride, nitrate, or sulfate.

5. The method of claim 1, wherein the crystalline salt matrix is a crystalline alkali metal halide, an alkaline earth metal halide, an alkali metal nitrate, an alkaline earth metal nitrate, an alkali metal sulfate, an alkaline earth metal sulfate, or a combination thereof, preferably CaCl₂, NaCl, KCl, NaNO₃, KNO₃, Na₂SO₄, K₂SO₄, MgSO₄, or a combination thereof.

6. The method of claim 1, wherein the amine is ammonia, methyl amine, ethyl amine, propyl amine, cyanoamine, cyanamide, cyanourea, melamine, dicyandiamide, or a combination thereof, more preferably ammonia.

7. The method of claim 1, wherein the carbonaceous material is methane, propane, butane, pentane, hexane, or any combination thereof, more preferably methane.

8. (canceled)

9. The method of claim 1, wherein the admixed two-dimensional transition metal nitride and the crystalline salt matrix, is separated by dissolving the crystalline salt in an aqueous solution.

10. (canceled)

11. The method of claim 1, wherein the transition metal precursor, dispersed within a crystalline salt matrix, is prepared is prepared by coating the crystalline salt with a solution or suspension, preferably an alcoholic solution, of the transition metal precursor, and removing the solvent from the solution or suspension.

12. The method of claim 1, wherein the transition metal precursor is non-crystalline.

13. The method of claim 1, wherein the non-oxidative or inert environment is substantially free of oxidizable species, such as air or oxygen, where substantially free refers to the absence of oxidizable species sufficient to compromise the reactivity of the amine or the integrity of the corresponding two-dimensional transition metal nitride.

14. The method of claim 1, wherein the non-oxidative or inert environment comprises the use of nitrogen, argon, or other gas that is non-reactive under the reaction conditions, and the use of a crystallizing salt that is non-reactive under the reaction conditions.

15. The method of claim 1, wherein the weight ratio of the transition metal precursor to the salt is in a range of from about 1:1 to about 1:10, from about 1:10 to about 1:100, from about 1:100 to about 1:500, from about 1:500 to about 1:1000, from about 1:1000 to about 1:2500, from about 1:2500 to about 1:5000, or a combination of two or more of these ranges.

16. The method of claim 1, further comprising separating the corresponding crystalline two-dimensional metal nitride composition from the salt matrix.

17. (canceled)

18. A composition comprising a layered array of crystalline two-dimensional metal nitride, present as flakes, said flakes prepared by or preparable by the method of claim 1.

19. (canceled)

20. The composition of claim 18, wherein the layered array of crystalline two-dimensional metal nitride further comprises an alkali metal sulfide.

21. The composition of claim 20, wherein the alkali metal sulfide is a lithium, sodium, or potassium sulfide.

22. (canceled)

23. (canceled)

24. An electronic device comprising a composition of claim 18, wherein the electronic device is an energy storage device.

25. (canceled)

26. A composition, comprising: a layered array of crystalline two-dimensional transition metal nitride or a layered array of crystalline two-dimensional transition metal carbide.

27. The composition of claim 26, wherein the layered array of crystalline two-dimensional metal nitride or transitional metal carbide further comprises an alkali metal sulfide.

28. The composition of claim 27, wherein the alkali metal sulfide is a lithium, sodium, or potassium sulfide, preferably a lithium sulfide, more preferably Li₂S or Li₂S₆.

29. The composition of claim 26, wherein the composition is characterized as an anode in an electrical cell or as a cathode in an electrical cell.

30. The composition of claim 26, further comprising an amount of a MXene material.

31. The composition of claim 26, wherein the composition comprises one or more of CrN, TiN, NbN, and Cr₂C.

32. The composition of claim 26, wherein the composition is characterized as a freestanding film.

33. The composition of claim 26, further comprising an amount of lithium disposed therein.

34. An electrical cell, comprising a cathode comprising the composition of claim 26 and further comprising an electrode that comprises lithium.

35. A battery, comprising:
a. a cathode, the cathode comprising an amount of two-dimensional transition metal carbide and/or transition metal nitride, and an amount of sulfide or sulfur, the cathode further optionally comprising an amount of a MXene material;
b. an anode, the anode comprising an amount of two-dimensional transition metal carbide and/or transition metal nitride, and an amount of lithium, the anode further optionally comprising an amount of a MXene material.
